(19) United States
(12) Patent Application Publication
(10) Pub. No.: US 2017/0138332 A1
(43) Pub. Date: May 18, 2017

(54) MODULAR GUIDED TRAVELING VESSEL POWER GENERATOR SYSTEM AND METHOD FOR GENERATING POWER

(71) Applicant: Corporacion Andina De Fomento, Atlamira (VE)

(72) Inventors: Maria PARENTE, Distrito Capital (VE); Jose Toran, Distrito Capital (VE)

(21) Appl. No.: 15/353,019

(22) Filed: Nov. 16, 2016

Related U.S. Application Data
(60) Provisional application No. 62/255,894, filed on Nov. 16, 2015.

(51) Int. Cl. F03B 17/06; B63B 35/44; H02K 7/06; F03B 13/00; H02K 7/18

(52) U.S. Cl. CPC F03B 17/06; F03B 13/00; H02K 7/1807; H02K 7/06; B63B 35/44; B63B 2035/4466

(57) ABSTRACT

A modular guided traveling vessel power generator system is provided, which has at least a vessel propelled by a fluid current with orientation means, for rotating around a pivoting axis by means of a pivoting element attached to a guiding system configured for guiding the vessel in a linear alternative direction perpendicular to the fluid current. The system has a transforming mechanism configured for transforming the linear movement of the vessel into another movement which drives at least a power generator unit. Additionally, a method for generating power is provided, which comprises pivoting a vessel propelled by a fluid current around a pivoting axis, guiding it in a linear alternative direction perpendicular to the fluid current, and transforming the linear movement of the vessel into another movement which drives at least a power generator unit.

### CROSS REFERENCE TO RELATED APPLICATION

This application claims the benefit of priority of U.S. Provisional Patent Application No. 62/255,894, filed on Nov. 16, 2015, the contents of which is incorporated herein in its entirety by reference.

### FIELD OF THE INVENTION

The present invention is encompassed within the field of power generation, specifically within the field of renewable energy technologies, and more specifically hydrokinetic power technologies.

This invention relates, in particular, to a modular guided traveling vessel power generator system including at least a floating vessel propelled by action of a fluid current and moving perpendicularly to such current by means of a guiding system. The movement of the vessel along the guiding system generates mechanical power by means of different mechanical devices.

Additionally, this invention relates to a method for generating power using at least a floating vessel propelled by a fluid current and the moving thereof perpendicularly to such current by means of the guiding system.

### BACKGROUND OF THE INVENTION

Development and marketing of renewable hydrokinetic power technologies of low (5 kW) and medium (250 kW) power to provide energy to isolated rural communities near navigable rivers in basins around the world, such as the West Amazon basin and others in Africa and Asia, is a short-term priority due to the high costs of electric energy in isolated communities in these basins. Currently, the governments of these regions are interested in improving the quality of life of communities there, and in reducing the high subsidies that are currently being used to provide energy to these areas. Electric power in these communities is usually provided by small diesel generators that are very high cost to operate, since diesel must be transported hundreds of kilometers by boats.

Taken into account geographic, ecologic, and climate conditions, as well as the difficult access, areas such as the central part of the West Amazon basin have few economically feasible technologic alternatives to bring electricity to their communities. The conventional network extension modality commonly used to provide electricity to rural communities and to connect them to the interconnected system is not feasible in these areas not only because of their long distances, but also due to the density of the tropical forest, and how inaccessible and dispersed the communities are.

Another conventional modality currently used to provide electricity to isolated rural communities such as the West Amazon, is bringing electricity through network extensions of the isolated systems under concession. The use of this modality is only feasible in communities that are relatively close to departmental or provincial capitals that have isolated systems under concession. Electricity has already been provided to one part of the West Amazon area through the extension of the network from diesel generation isolated systems, located primarily in the provincial and municipal capitals.

The introduction of new technologies to provide electricity to isolated communities in tropical basins is a way to solve this problem, while at the same time it provides support to the technological capacities to strengthen the region's innovative system.

Hydrokinetic power conversion systems from river currents have been implemented since ancient times. The development of hydrokinetic power converters for high-flow rivers, but with very low hydraulic or water head, is in its initial stages. There are very few technologies available on the market, currently only two: a) Garman axial flow-type turbines; and b) Darrieus cross flow vertical axis turbines. The available Garman turbines have a very low capacity (1 to 2 kW), but greater capacity Darrieus-type turbines can be found in the market (5 to 25 kW). Both types of turbines need a minimum speed of 1.5 m/s to work effectively, and this would limit its use in a great number of the rivers considered in the central area of the West Amazon basin, where the average speed of the flow of water is between 0.9 to 1.3 m/s. Both types of turbines would also be exposed to the risk of being hit by floating material (trees, branches, roots, etc.), which is very common in Amazon rivers.

Therefore, there exists a need for development of technological concepts oriented to work efficiently (i.e., generation of electricity affordably) in rivers with the conditions and features mentioned above. These new technologies should comply with the following parameters: a) the technology should be modular, and should include the full hydrokinetic power conversion systems or processes, and should function independently from other structures; b) the main source of energy should be hydrokinetic, considering speeds of river flows ranging between 0.9 to 1.5 m/s; c) the technology should be designed for capacities starting from 1 kW of power and up; d) the technology should consider the risks of being impacted with floating material (trees, branches, roots, etc.), which are very common in navigable rivers, especially in basins such as the Amazon Basin and others.

### SUMMARY

The present invention relates to a modular guided traveling vessel power generator system.

This modular guided traveling vessel power generator system has a floating vessel which moves in alternative direction perpendicularly to the direction of a fluid current, along a guiding system, which may be fixed or moveable. This movement of the vessel is achieved by effect of the propelling action of the current against a submerged part of the vessel which is placed obliquely to the current direction, producing a mechanical power output. This mechanical power is transmitted to a transforming mechanism which may transform this mechanical power into rotational movement of a shaft or to produce other kind of mechanical displacements in order to drive either electrical generators or any other mechanical device like pumps, compressors, mixers, but not limited to them.

There are several different embodiments of the system, all of them according the same basic operating principle but with differences respect to the guiding system of the vessel and the transforming mechanism which finally drives the power generator.

Additionally, the present invention relates to a method for generating power using at least a floating vessel propelled by a fluid current and the moving of such floating vessel perpendicularly to the current by means of the guiding system.

It is a main aim of the present invention to use the hydrokinetic power of a water current source in order to transform it into mechanical or electrical power.

It is an additional aim of the present invention an easy placement of the system on any spot of a water channel, mainly rivers, depending on the features of such channel, especially due to seasonal changes in flow, water level, sediments or any other reason associated to improve the system performance, safety, or convenience, without requiring any major civil foundations or construction.

It is also an aim of this invention to operate in a reliable way in remote areas with no human labour during operation and minimal maintenance intervention.

It is another aim of the present invention to provide a resistant structure and necessary mechanisms required to survive for collisions with elements being dragged by the water current, such as trees, branches, roots, etc.

It is another aim of the present invention to be easily transported long distances by any means, especially when being towed or shipped by any small or medium size river craft.

It is another aim of this invention to provide power generation modules that can be combined in different arrangements in order to increase power output level obtaining power output uniformity, maximizing benefit of water source conditions and adaptations to changes on the water source channel.

It is another aim of the present invention to easily adapt the number and size of the modules of power generation to the power demand or users' requirements. It is also an aim to scale the number and size of the elements depending on the flow or demand conditions.

It is another aim of the present invention to provide a simple maintenance device, considering it may be operating in remote areas far from technical service providers or spare parts suppliers.

In order to accomplish these aims it is provided a modular guided traveling vessel power generator system which comprises at least a power generator system module. Each module comprises a floating vessel, a guiding system for the floating vessel, a power transforming system and a power generation unit.

As stated above, there are several embodiments, all of them working according the same operating principle, which is a floating vessel being propelled by the water current describing an alternative rightwards-leftwards linear movement, always perpendicular to the water current because of the restriction of the guiding system, which also limits the length of the travel of the vessel in every direction, and with the movement of the vessel trailing another element which will transform the linear movement of the vessel into a rotational movement of a shaft or another linear movement in order to use this mechanical power to drive any electrical generator or mechanical device.

The floating vessel has different parts, mainly a front part or bow, a rear side or stern, a pivoting element, the fins. The front part or bow is considered the side of the boat facing the water current (upstream side), mainly comprising the area from the pivoting element up to the front nose or leading edge on the vessel movement direction. The rear side or stern of the vessel is opposite the front part or bow, comprising the area or elements from the pivoting element down to the back end or trailing edge on the vessel movement direction (downstream part). The pivoting element is attached to the guiding system and to the pivoting axis of the vessel when it rotates to reorient its bow respect to the current in order to reverse its moving direction. The fins are the elements permanently submerged, attached to the bottom of the vessel, which are capable of rotate on their own axes to define the moving direction of the vessel, acting as an airfoil to generate the force to move the vessel. The terms vessel, boat, barge, raft, ship or craft could be used indistinctly along the summary to refer to the vessel.

Additionally, the rightwards and leftwards directions of the vessel are considered referring to the point of view of an observer located in the vessel whose front direction of view is looking at upstream direction (facing against the water current), in order that the leftwards or rightwards direction of motion correspond to the left or right hand directions of the observer. So, both rightwards and leftwards directions are perpendicular to the current direction. An alternative naming for these moving directions could be using port side instead of leftwards and starboard side instead of rightwards.

The operating principle of the traveling vessel is the orientation of the longitudinal axis of the vessel to an angle higher than 0° degrees and lower than 90° degrees respect to the current direction, called the attack angle, in order to convert the kinetic energy of the water current into a propelling force on the vessel side (the one facing the current) and the submerged fins. This propelling force has two main components, one of them perpendicular to the current direction, which will be the direction of the movement of the vessel moving, and it is called lift force, and another on the water current direction called drag force. The value of the forces can be calculated according to the moment transfer theory in such a manner that the forces will be proportional to the water mass flow and its velocity, the area of the vessel and fins facing the current, and the attack angle. The closer the angle to 90° degrees, the higher the drag force and the minimal the lift force, while an angle closer to 0° degrees will provide a minimal drag and almost zero lift force (assuming a symmetric profile). The higher the lateral area of the vessel the higher the forces. The higher the velocity of the fluid and its density the higher the force. As the vessel moves on the lift force direction, it also appears a second drag force (as a frictional force between the vessel and the fluid) this one in opposed direction to the lift force, and this must be minimized in order to obtain the most energy from the water current. To achieve this goal, aerodynamic studies on the vessel must be performed to obtain the appropriated shape, which will depend also of the attack angle selected.

The vessel moves linearly in a fixed length travel, inverting its direction once it reaches the end of the travel, which usually is the opposite side of the river, but it may be other fixed end. The change of direction at the end of the travel of the vessel either leftwards or rightwards may be achieved by means of two different methods, which are the keels method and the inertia method.

The keels method is performed by the keel or keels of the vessel, which are activated to rotate on its own axis once the vessel reaches the end of the travel. In the case of a single keel, its rotation axis will be located on the same axis that the pivoting element of the vessel, and in the case of several keels, they will be grouped in bow keels and stern keels with the keels belonging each group rotating simultaneously, being distributed along an imaginary longitudinal axis of the vessel. Each keel act as an airfoil, it means that the aerodynamic effect of the current on it will produce mainly two forces on the keel, one called lift force, which is perpendicular to the current, and another called drag force, in the same direction of the current (downstream). The value of these forces varies depending on the geometry profile and the angle in which the front nose of the keel or a longitudinal axis of it have with respect to the current direction. It is assumed for a normal operation of the present invention that both movements of the vessel on leftwards and rightwards directions are intended to have the same conditions, for this reason the proposed geometric profile of the keel should be symmetrical respect its longitudinal axis. In case of a use of the device which implies different conditions for each travel, the geometric profile shouldn't be symmetrical. Every keel has a “neutral position” when its longitudinal axis is aligned with the current, it means it receives zero lift force, and a “traveling position” when it rotates from its neutral position with an angle less than 90 degrees, when it produces a lift force in the opposite direction. The operating principle is analogous to a sail on a sailing boat in a wind current. The procedure to rotate the vessel to reorient it respect to the current consists on setting the stern keels group into its neutral position while keeping the bow keels group on its traveling position in such a manner that the stern keels group minimize its drag force while the other group is dragged by the current, producing a rotation of the vessel around its pivoting axis. Once the attack angle is reoriented the stern keels group rotates back to its original position. The bow side of the vessel becomes the stern side after it reorients to move rightwards. The keels remain at a fixed position while the vessel travels in both directions; they only rotate on the reorienting or transition stage at the end of every travel. This method would permit to reorient any vessel with no limit on size, and it is especially useful on low speed water currents. A keels mechanism makes the keels to rotate on the proper direction once the vessel reaches the end of the travel, and additionally locks and unlocks the keels to allow rotation or to fix the position thereof.

The second method for reorienting the vessel is the inertia method, and it works by either pulling the vessel with a fixed cable or a mechanical element, or pushing the vessel with a fixed stopper directly on the vessel to make it rotate on its pivoting axis, in order to invert its traveling direction. In this case the force required to produce the rotation of the vessel comes from the energy from a flywheel or any element which exerts a force on the vessel or a transmission element acting on it, not from the water current as in the keels method. By means of this inertia method the vessel always maintains the same portion of its hull as the bow, when moving leftwards or rightwards, and the keels are fixed during the operation. The use of this inertia method is limited to small size vessels with small attack angles because the force required to make it turn will be proportional to the size of the vessel and its velocity. It could not be possible to generate the rotation in the case of medium or large size vessels on slow water currents by using this method.

To increase the rotating capability of the system it would be required any kind of energy accumulator as flywheels to storage the energy from the moving vessel in order to release it at the moment of the reorienting effort. It is not required the rotation of the keels to create the torque to rotate the vessel when using the inertia method, but a rotation of them could be advantageous in order to reduce the resisting force of the vessel during the reorientation.

According a first embodiment, the present invention comprises a guiding system comprising two fixed parallel guiding cables or metal bars, one of them the pulley cable and the other one the pivoting cable, both of them tied at their ends to fixed posts placed inland or on the water riverbed, aligned perpendicular to the water current direction. The guiding system additionally comprises a pulley system that rolls over the pulley cable, keeping the vessel attached to it by means of two handling bars, which define the attack angle of the vessel by shortening or enlarging the distance between the pulley system and the attaching point on the vessel of each handling bar. The vessel will move on the direction of the shortest handling bar, so, for instance, if the left handling bar is shorter than the right handling bar, the vessel will move leftwards. The guiding system also comprises a locking mechanism on the attaching points of the handling bars, which allows locking and unlocking the bars at the end of the travels when the vessel rotates around its pivoting element. The pivoting element is an articulated joint on the vessel that runs over the pivoting cable. The contact between the pivoting cable and the pivoting element may be through a bushing or sleeve or it may be through a pulley array. The reason for having two fixed guiding cables is to have one of them for the two handling bars, and the other one for the pivoting element, giving more stability to the vessel movement and allowing to distribute the overall force on the vessel over the three joints (two from the handle bars and one from the pivoting element), allowing it to resist higher forces, which could imply having large vessels.

According to different solutions for the first embodiment of the present invention, the power generator system may have different transforming mechanisms associated to transform this mechanical power into another kind of power. A first of them uses the rotation of the pulleys of the pulley system rolling over the fixed guiding pulley cable, in order to drive any electrical generator or mechanical device. In case of using also pulleys to attach the articulated joint of the pivoting element with the pivoting cable, the rotation of those pulleys can also be used to drive a power generator unit. A second mechanism uses the force of a trailing cable attached to the vessel to transform the linear movement thereof into another mechanical linear movement or into a rotational movement on a pulley or reel in order to drive any electrical power generator or mechanical device.

This first embodiment is a robust solution for large size vessels because of the multiple attachments between the vessel and the guiding system, which distribute the total force received by the vessel into all the attachments. In case of using smaller size vessels, as the force on the vessel will be also smaller, it can be reduced the number of attachments simplifying so the guiding system. This is one of the purposes of a second embodiment.

According to this second embodiment of the present invention, the guiding system comprises a single guiding cable or bar, tied at their ends to fixed posts placed either inland or in the riverbed, perpendicular to the water current direction. In this embodiment the vessel attaches to the cable either through a pulleys array, or through a sleeve or bushing articulated at the pivoting axis of the vessel, allowing it to run over the cable. In this embodiment, there is a locking mechanism that controls the rotation of the vessel around its pivoting axis, in order to maintain a fixed position (the attack angle) during the movement along the travel, and allowing it to rotate over it at the end of the travel in order to reorient. This locking mechanism is coupled with the keels mechanism, and both mechanisms are activated or deactivated when the vessel reaches the end of the travel in any direction. The second embodiment simplifies the guiding system with respect to the first embodiment, but also could limit the size of the vessel as all of the forces will be handled by a single joint element. This would imply using several vessels working in parallel, preferably linked together on the same cable, so in these cases the modular system of the present invention will have several vessels. The transforming mechanisms and the power generation methods for the second embodiment may be the same that in the case of the first embodiment. The reorientation of the vessel at the end of travel can be achieved either by the keels method or by the inertia method.

According to a third embodiment, the present invention comprises a guiding system with a single guiding cable or bar tied at their ends to fixed posts inland or in the riverbed, arranged perpendicular to the water current direction on which a bushing or sleeve element runs along, and which is joined to the vessel through an articulated joint. There is a rod and crank mechanism, with the rod element articulated in one of its ends to the vessel or the sleeve element, being trailed when it moves during the vessel travel, and the other end of the rod element joined to the crank element which will produce a same direction rotation on a spindle shaft as the vessel moves leftwards and rightwards. The spindle shaft is used to drive any electrical power generator or mechanical device. There is a mechanism that locks the vessel respect the sleeve to maintain the attack angle during the travel, and to unlock it at the end of the travel to allow it rotating and reorienting on the opposite direction, as in the case of the second embodiment. Both the vessel locking mechanism and the keels mechanism are activated by mechanical contact or by a cable pulling once the vessel reaches the end of the travel in any direction.

The single guiding cable or bar of the third embodiment can be used to combine more than one vessels acting together to trail a single rod, or alternatively a single vessel can be attached to two rods simultaneously acting in opposed directions in order to drive two different power generators at a time. According this embodiment, the system becomes a modular solution that allows incorporating more moving vessels to a single shaft and power generator unit, or mechanically interconnecting several power generator units through shared rods and vessels elements. The main advantage of this modularity is to increase the power generation capabilities of any location by adding more modules or rearranging the existing ones sharing a single guiding system. Additionally, regarding maintenance, having a system with interchangeable modules is an advantage, since one or several modules may be repaired while the others are working.

It is a key for an efficient performance of this third embodiment to have light and stiff rod and crank elements, which could involve using trusses like structural members. It could be also useful in case of remote locations the use of native materials and elements like woods and bamboo rods. The length of the rod and crank elements is interdependent and they will determine the length of the travel of the vessel in every direction. Different combinations of rod and crank element length can be used for the same device, depending on the expected performance of the system. For this reason, adjustable length rod and crank elements are provided in order to make a more flexible system, adaptable to different operating environments and conditions. It is a well-known fact from the four-bar mechanism studies that the crank element length is directly proportional to the travel of the sleeve and vessel, and that the rod element must be longer than the crank element.

According a fourth embodiment, the present invention has one or several vessels and a moveable and deformable guiding system having either a sliding bar or an articulated extensible and compressible linkage similar in shape to the mechanism popularly known as “lazy tong”, both of them with part of it anchored to a dry land spot, and the other end free to extend over the river, in perpendicular direction to the water current. The vessels are attached to some of the joints of the bar or the linkage, in such a manner that when all vessels move together on one direction by the propelling effect of the water current on each of them, the guiding system will shorten or lengthen. Once the guiding system reach the end of the travel all the vessels rotate together to reorient its moving direction either using the keels method or the inertia method. In this embodiment the vessel has no relative movement respect to the guiding system, both moves together while it changes its in-water length. The length of the travel of the vessels can be adjusted by limiting the deformation of the guiding system, with fixed stoppers, or by means of a fixed length cable which pulls the vessel or the structure when it gets to its free end. The change in length of the linkage is used to generate mechanical or electrical power in at least three different ways. The first one refers to the transformation of the linear displacement of a bar articulated in one of its ends to one of the joints of the linkage into a rotational movement of some transmission elements and of an electrical power generator or any other mechanical device. The second one refers to the change in relative position between two elements of the linkage as the vessels move, to activate any piston pump mechanism, in order to pump water from the river onto an energy accumulator or directly into a Pelton turbine, which will drive an electrical power generator. The third one refers to the change in angle between two links to transform it into a spindle shaft, which will be used to drive any power generator.

This fourth embodiment is also considered modular because more linking elements can be added to the bar or linkage mechanism in order to increase its length, and as it grows up more vessels can be attached to the structure in order to generate a higher force to drive the power generation units. Another advantage of increasing the length of the guiding system is to reach further distance from the shore line, which is important in case of variation of the river flow due to seasonal changes, because it allows setting the vessels on a section of the river with more water flow and velocity. In case the area close to the riversides gets dry because of tidal or seasonal effects, the vessels located on those dry zones are easily disengaged from the linkage in order to keep only the ones on water zones working. Once the river gets back to its normal water level the removed vessels are reengaged to the linkage.

In order to increase the resistance of the guiding system to be dragged by the water current, it is included a tension cable which is winded or un-winded in a reel as the linkage shortens or lengthens, driven by the same means as the electrical power generator.

The flexibility of the fourth embodiment linkage to allow placing a mechanical structure at different positions into the river from the shore line without requiring any foundation or pilotage on the riverbed, and the independence of any external mechanical or electrical power source to drive it, makes the invention to be used alternatively to the power generation purposes to act as a river dock or anchoring for any other river devices or boats, to work as a cargo or passengers mover and also to work as a retractable bridge.

Other uses of the present invention may be controlling the placement of elements into the river from a single side of the river or water channel anchorage, which uses the energy of the water current to drive the motion of the device. These uses include holding and deploying nets for fishing, cleaning the water flow, protecting from object being dragged by the water current, operations like river dredging or any other mechanical activities related but not limited to the mentioned. A difference between the power generation application and the non-power generation applications disclosed is that in the power generation the system moves continuously in alternating direction cycles without requiring human intervention, while the non-power applications require the user intervention to control the extend of the device in the river, and the system is not necessarily intended to be in constant motion, but mainly standing still to perform its function. Both kinds of applications share the use of the water current energy like the only source of power to drive the motion of the device.

According a fifth embodiment, the present invention has one or more moving vessels without relative movement regarding a moveable guiding cable passing through a pulley system located outside or inside the river which will be fixed to the vessel and trailed as it moves perpendicular to the water current. The transforming system for this embodiment is the cable and the pulley system, which will drive the power generator with the rotation of the pulleys. A mechanical mechanism that inverts the rotation of the spindle shaft driving the power generator is provided in order to maintain always the same direction of rotation on the power generator no matter the moving direction of the vessel. According this fifth embodiment the vessel reorientation can be achieved preferably by means of the alternative rotation method, which would require the use of a flywheel attached to the pulleys, in order to provide enough force on the moving vessel at the end of the travel to make it rotate on its pivoting axis, by either being pulled by a cable or pushed by a rigid element any of them fixed to the same structure holding the pulleys.

The present invention additionally relates to a method for generating power, which includes de steps of orientating and pivoting a floating vessel propelled by a fluid current around a pivoting axis, guiding the floating vessel in a linear alternative direction perpendicular to the fluid current, and transforming the linear movement of the floating vessel into another movement which drives at least a power generator unit.

According a particular embodiment, the method of the present invention includes orientating and pivoting the floating vessel comprises rotating at least a keel around a rotating axis of the keel parallel to the pivoting axis.

Alternatively, the orientation and pivoting of the floating vessel can be achieved exerting a force over the vessel by means of inertial means and rotating it around the pivoting axis.

With accord to different particular embodiments, transforming the linear movement of the floating vessel to drive at least a power generator unit comprises driving electric power generator units by means of pulley mechanisms rolling over guiding means.

All the embodiments disclosed are capable of resisting collisions with solid bodies and debris being dragged by the water current. The only element in the way of such objects is the floating vessel, and due to the kind of guiding systems used and the degrees of freedom of the vessels, it can easily move out of the way of the object to let them pass. The most vulnerable element on the vessel to collisions are the keels located at the bottom of the vessel, and for this reason they are provided with a collapsible spring loaded fixation element which yields and folds to avoid breaking the keel when collision occurs, staying straight while the vessel is operating. The construction of the vessel hull must be durable to these impacts so the materials and techniques proposed are the ones used on commercial river boats, specially the “rotomolded” polyethylene like some sea kayaks, aluminum and even wood. It is not recommended the glass or composed fibers due to its low resistance to impacts.

All of the constructive elements of any of the embodiments disclosed are modular and separable which makes them easily stackable and transportable by river boats for long distances.

There is not a prefixed dimension for any of the elements, because the larger the vessel side perimeter, the higher the force obtained from the water current, and the larger the travel of it along the guide element the better the continuity of the power system, considering that larger pieces represent disadvantages to manufacturing and transportation of such elements, and could be harder to make it rotate during the reorienting phase at the end of the travel.

The features, functions and advantages that have been discussed can be achieved independently in various embodiments or may be combined in yet other embodiments further details of which can be seen with reference to the following description and drawings.

### BRIEF DESCRIPTION OF THE DRAWINGS

Next, in order to facilitate the comprehension of this invention, in an illustrative rather than limitative manner a series of embodiments with reference to a series of figures shall be made below.

FIG. 1 is a schematic perspective view of a first embodiment with the vessel traveling leftwards.

FIG. 2 is a schematic top view of the first embodiment with the vessel traveling leftwards.

FIG. 3 is a schematic front view of the first embodiment showing the position of the vessel respect to the river section.

FIG. 4 is a partial perspective view of the first embodiment including the pulley guiding system, without the power generation units.

FIG. 5 is a top view of the main pulley guiding mechanism.

FIG. 6 is a top view of the secondary pulley guiding mechanism.

FIG. 7 is a partial perspective view of the first embodiment including the pulley guiding system with the power generation units attached and the trailing cable with the in-land power generation unit.

FIG. 8 is a partial perspective view of the first embodiment with the vessel guided by sleeves or bushings.

FIGS. 9a to 9h are a sequence of partial bottom views of the first embodiment showing the reorientation of the vessel by means of the keels method.

FIG. 10 is a perspective view of a second embodiment with the vessel traveling leftwards, including a pulley mechanism guide

FIGS. 11a to 11e are a sequence of top views of the second embodiment showing the reorientation of the vessel by means of the inertia method, with the vessels traveling leftwards, reorienting and then starting the travel rightwards.

FIG. 12 is a top view of the second embodiment including an arrangement of two vessels traveling rightwards using the pulley mechanism guide.

FIG. 13 is a perspective view of a third embodiment showing the transforming crank mechanism.

FIGS. 14a to 14f are a sequence of top views of the third embodiment showing a complete cycle of traveling leftwards, reorienting by means of the keels method and traveling rightwards.

FIGS. 15a to 15e are a sequence of top views of the third embodiment with the vessel traveling leftwards and reorienting by means of the inertia method.

FIG. 16 is a perspective view of an arrangement of the third embodiment including three vessels, showing the three possible combinations of elements.

FIGS. 17a to 17f are a sequence of top views of an arrangement of vessels of the third embodiments showing a complete cycle, reorienting the vessels by means of the inertia method.

FIG. 18 is a comparative partial top view of the third embodiment showing the start and end of a travel of the vessel, comparing two different length sets of crank and rod elements, and their influence in travel length.

FIG. 19 is a perspective view of a fourth embodiment including a sliding bar and three vessels attached while traveling leftwards.

FIGS. 20a to 20f are a sequence of top views of the fourth embodiment including the sliding bar and three vessels attached, showing a complete cycle traveling leftwards and then reorientation by means of the inertia method.

FIG. 21 is a perspective view of the fourth embodiment with an articulate linkage and three vessels attached traveling leftwards, showing a first power generation method by means of a sliding rack and pinion.

FIG. 22 is a partial perspective view of the fourth embodiment showing the power generation method by means of the sliding rack and pinion and by pressurizing liquids by piston pumps.

FIGS. 23a to 23c are a sequence of three top views of the fourth embodiment with articulated linkage traveling leftwards, showing the operation of the three power generation methods.

FIG. 24 is a top view of a first non-power generation use of the fourth embodiment working as a flexible anchorage for other power generation devices.

FIG. 25 is a top view of a second non-power use of the fourth embodiment working as a flexible docking for boats.

FIG. 26 is a top view of a third non-power use of the fourth embodiment working as a cargo or passenger transport device.

FIG. 27 is a top view of a fourth non-power use of the fourth embodiment working as a removable bridge.

FIGS. 28a to 28b are a sequence of partial perspective views of the fourth non-power use of the fourth embodiment showing hinge like modular floor platform in folded position during the travel of the device, and flat when it reaches destination.

FIG. 29 is a perspective view of a fifth embodiment with one vessel traveling leftwards.

FIG. 30 is a perspective view of the fifth embodiment with an arrangement of two parallel vessels traveling leftwards.

FIG. 31 is a top view of the fifth embodiment with two vessels attached to opposite sides of the same transmission element traveling in opposite directions.

### DETAILED DESCRIPTION

The present invention refers to a modular guided traveling vessel power generator system.

There are five embodiments of the present invention disclosed in detail, all of them having the same operating principle of a vessel 1 propelled by a water current, which describes alternating direction linear movements perpendicular to the current direction, each one of said alternating linear movement called “travel”. All embodiments comprise similar elements, but they differ from each other mainly on the guiding systems 2 and the transforming mechanisms 3 used.

FIG. 1 is a general view of a first embodiment of the present invention, which shows the main components of the system. The floating vessel 1 is the element propelled by the water current, which will move perpendicular to the current direction because its movement is restricted by the guiding system 2, for this embodiment comprising tense cables or rigid bars which are tied on both ends to fixed posts 3, which can be out of the water on the riversides like in FIG. 1 or can be within the riverbed. The present invention comprises additionally a transforming system 4, which transforms the linear movement of the vessel 1 into a rotational movement of a spindle shaft or into another linear movement in order to drive a power generator unit 5, which can be an electrical power generator or other mechanical devices like pumps, compressors, mixers, energy accumulators or any other device, but not limited to them.

FIG. 1 shows the transforming system 4 for the first embodiment, consisting in a pulleys arrange which rolls over the tense cable 2 transforming the relative linear movement of the vessel respect the cable 2 into a rotational movement of a spindle shaft that will drive the power unit generator 5.

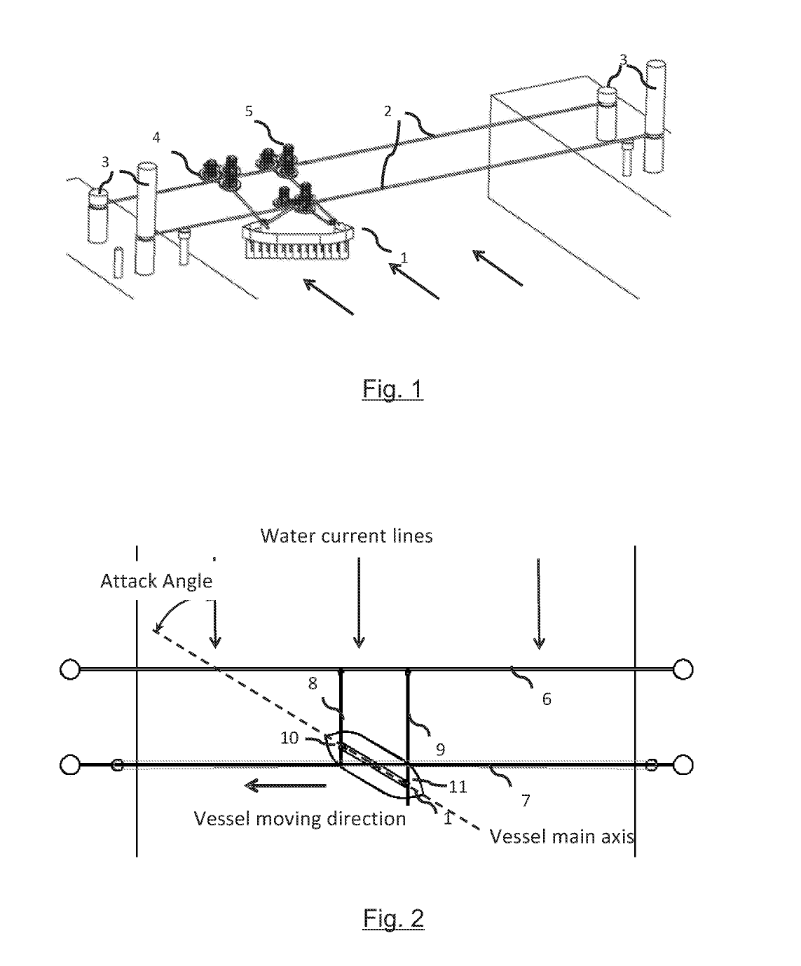

FIG. 2 is a general top view of the first embodiment of the present invention, showing the vessel 1 moving leftwards, the transforming system not represented for the sake of clarity.

Additionally, FIG. 2 shows the common fundamental working principle of all the embodiments of the present invention, which it is the orientation of the vessel 1 at a determined attack angle between 0 degrees and 90 degrees respect to the water current direction, which generates a lift force on the vessel perpendicular to the current direction. The difference between the five embodiment lies on the components involved on the operation. The guiding system 2 for the first embodiment comprises two fixed parallel cables, so called pulleys cable 6 and pivoting cable 7, on which the vessel 1 is attached by means of two handling bars 8,9. The attack angle in the case of the first embodiment is kept by means of the two handling bars 8,9, the left handling bar 8 and the right handling bar 9, attached by one of it ends to the pulleys cable 6 and having the other end attached to the vessel 1 through universal left joint 10 and right joint 11 provided with a locking mechanism, which maintains different lengths between the universal joints 10,11 and the pulleys cable 6, called the effective distance. One of the handling bars effective distance will be larger than the other handling bar, making the vessel 1 main axis being not parallel to the water current direction. FIG. 2 shows that the left handling bar 10 effective distance is shorter than the right handling bar 11 effective distance, what makes the vessel 1 to receive a left direction lift force from the water current, producing the leftwards displacement of the vessel 1. The water current also produces a drag force on the vessel 1 on the direction of the current, which is transmitted to the guiding cable 6 through the handling bars 8,9.

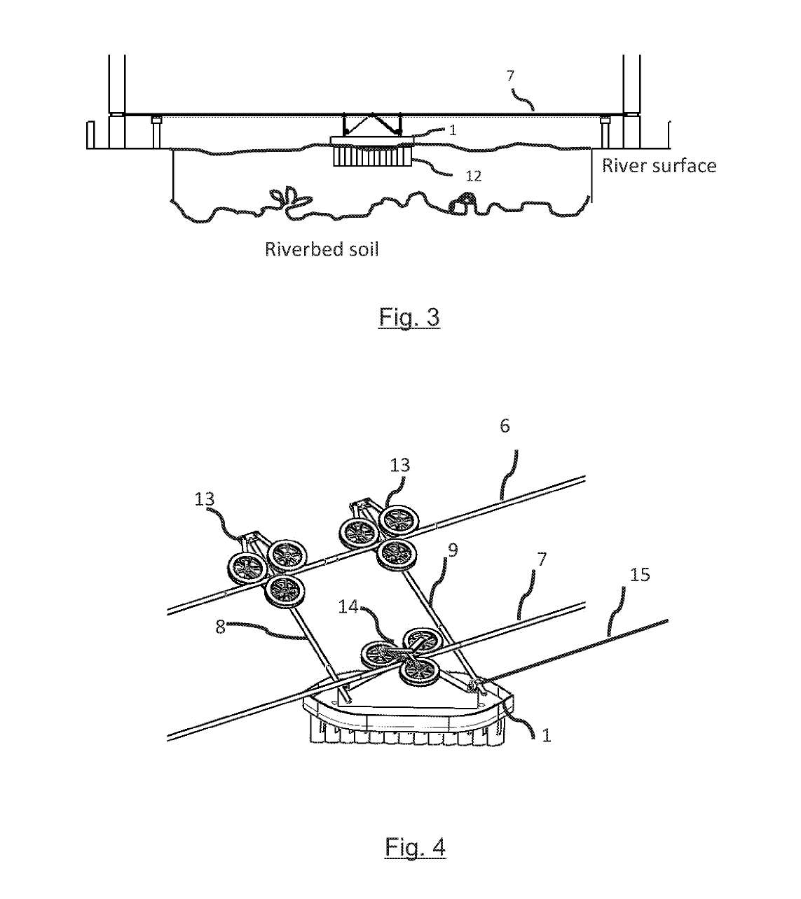

FIG. 3 is a front view of the first embodiment of the present invention, showing the location of the floating vessel 1 on the river. The water current produces a lift force on the submerged part of the vessel hull facing upstream and on the keels 12 located at the bottom of the vessel 1. As shown in FIG. 3, there is no contact of the vessel 1 or keels 12 with the river bed soil.

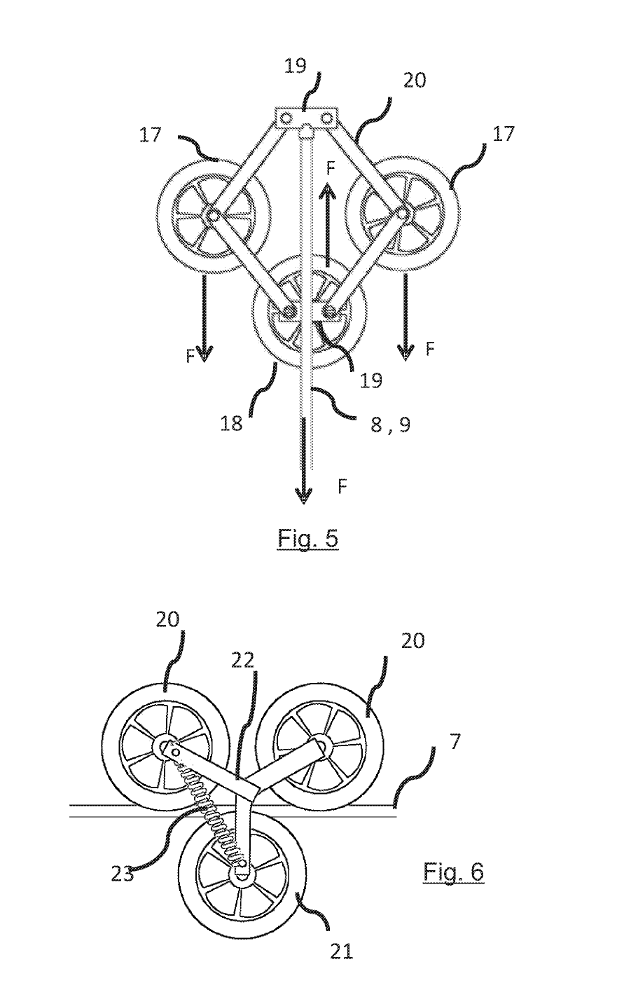

FIG. 4 is a partial view of the vessel 1 showing the linking elements between the handing bars 8 and 9 with the guiding cables 6 and 7 for the first embodiment. These linking elements are part of the transforming mechanism 4. In this case, these linking elements are a first pulley mechanism 13 which rolls over the pulleys cable 6, producing a low resistance displacement of the vessel 1 as it is guided. The first pulley mechanism 13 maintains always the handling bars 8, 9 perpendicular to the pulleys cable 6. The first pulley mechanism 13, as shown in detail in FIG. 5, comprises two first pulleys 17 at one side of the pulleys cable 6, and one second pulley 18 at the other side of the pulleys cable 6, which spins freely on bushings located on the four links 20 which links the pulleys 17,18 which form a deformable parallelogram linkage together with the plates 19. As the handling bars 8,9 receive a pulling force “F” coming from the drag force of the water current on the vessel 1, the linkage tends to close, which means that the first pulleys 17 tend to move downstream increasing the contact force against the pulleys cable 6, while the second pulley 18 moves upstream pushing against the pulleys cable 6. The force “F” on each handling bar 8,9 is a fraction of the total drag force on the vessel 1, and so it provides a suitable contact between the pulleys cable 6 and the pulleys 17,18 avoiding slipping between the cable 6 and the pulleys 17,18, which means friction and resistance to movement. In order to increase the friction between the surface of the pulleys 17,18 and the pulleys cable 6, a wiping element is provided to keep clean and dry the area of the pulleys cable 6 which contacts the pulleys 17,18.

FIG. 4 also shows the linkage between the vessel 1 and the pivoting cable 7. The vessel 1 has a universal rotating joint for a pivoting axis, on which a second pulley mechanism 14 is installed, which could work similarly to the first pulley mechanism 13 shown in FIG. 5. An alternative embodiment of this second pulley mechanism 14 is shown in FIG. 6, which has two third pulleys 20 and a fourth pulley 21 mounted on articulated links 22 loaded with springs 23 in order to provide always a normal force between each pulley 20,21 and the pivoting cable 7, said force being independent of the drag force over the vessel 1. Once again the aim is to avoid slipping.

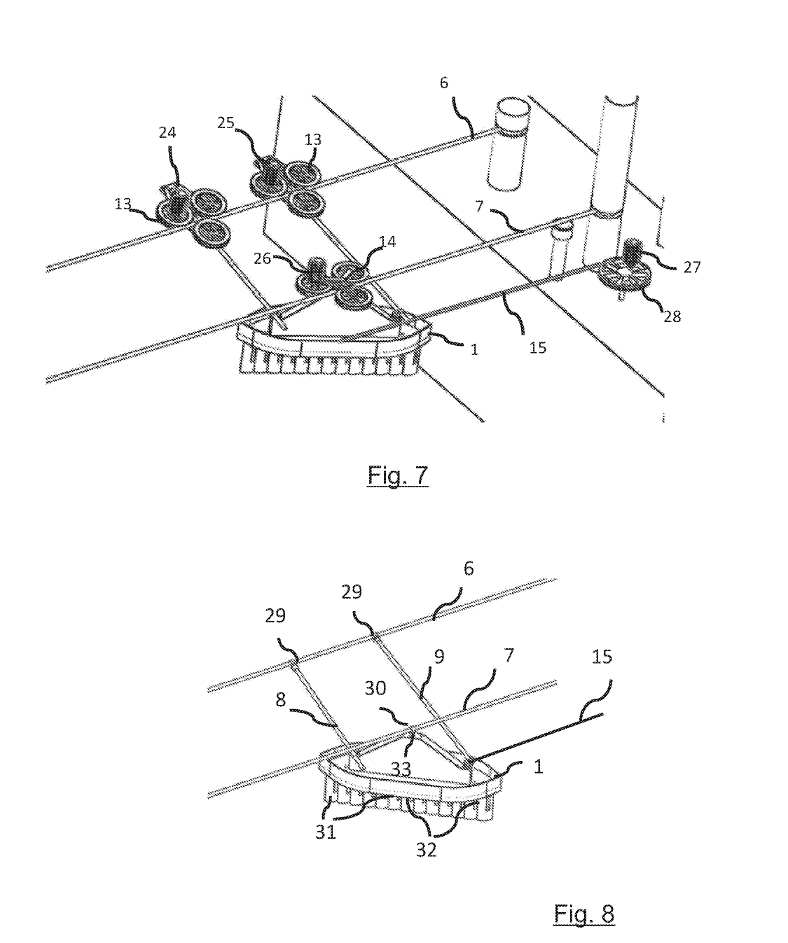

FIG. 7 shows power generation units for the first embodiment of the present invention. As the pulleys 17,18,20,21 of the pulley mechanisms 13,14 roll over the cables 6 and 7 without slipping when the vessel 1 perpendicular to the water current, the rotation of such pulleys 17,18,20,21 is used to drive electric power generator units 24,25,26, which placed on the pulleys mechanisms 13,14. The electric power generator units 24,25,26 can be coupled to mechanic transmission elements driven by one, two or three of the pulleys of each pulley mechanisms 13,14. The mechanic transmissions must provide a unidirectional rotation in the shaft of the electric power generator units 24,25,26 no matter the vessel 1 direction of movement. The mechanic transmission could also couple two or three of the pulley mechanisms 13,14 in order to reduce the number of electric power generator units 24,25,26 by having a higher torque single driving shaft. A fourth electric power generator unit 27 is driven by the rotation of a reel 28 which spins due to the action of a trailing cable 15 which is pulled by the vessel 1 when it moves. There is another mechanic transmission element connecting the reel 28 and the fourth electric power generator 27 in order to transform the rotational speed received by the fourth electric power generator 27 and to provide a unidirectional turning. Both the reel 28 and the fourth electric power generator 27 can be located in land or in any other location over the river, fixed to the cables 6,7.

FIG. 8 shows another solution for the first embodiment, using sleeves or bushings 29,30 instead of the pulley mechanisms 13,14 at the end of the handling bars 8,9. The bushings 29 provide low friction relative movement of the vessel 1 as they slip on the pulleys cable 6 and maintain always the handling bars 8,9 perpendicular to the pulleys cable 6. The only power generator unit installed on the embodiment of this FIG. 8 is the one driven by the trailing cable 15, pulled by the movement of the vessel 1, which can produce a rotation on an element 28 and drive the electric generator 27 as explained above regarding FIG. 7. This trailing cable 15 can also drive any other mechanical device requiring a linear force by means of a mechanical transmission.

The movement of the vessel 1 is linear and has a start point and an end point, defining the displacement of the vessel 1 between them, what is called “travel of the vessel 1”.

Once the vessel 1 reaches the end point at the end of the travel it reorients its main axis, as shown in FIG. 2, with respect to the water current, in order to invert the direction of the lift force of the current acting on it, what makes the vessel 1 to move on the opposite direction. The change of direction at the end of the travel of the vessel 1 may be achieved by means of two different methods, which are the keels method and the inertia method

Regarding the keels method, FIG. 8 shows the keels 12 split in two groups, the bow keels group 31 and the stern keels group 32. FIG. 8 also shows the pivoting element 33 around which the vessel 1 rotates when reorienting.

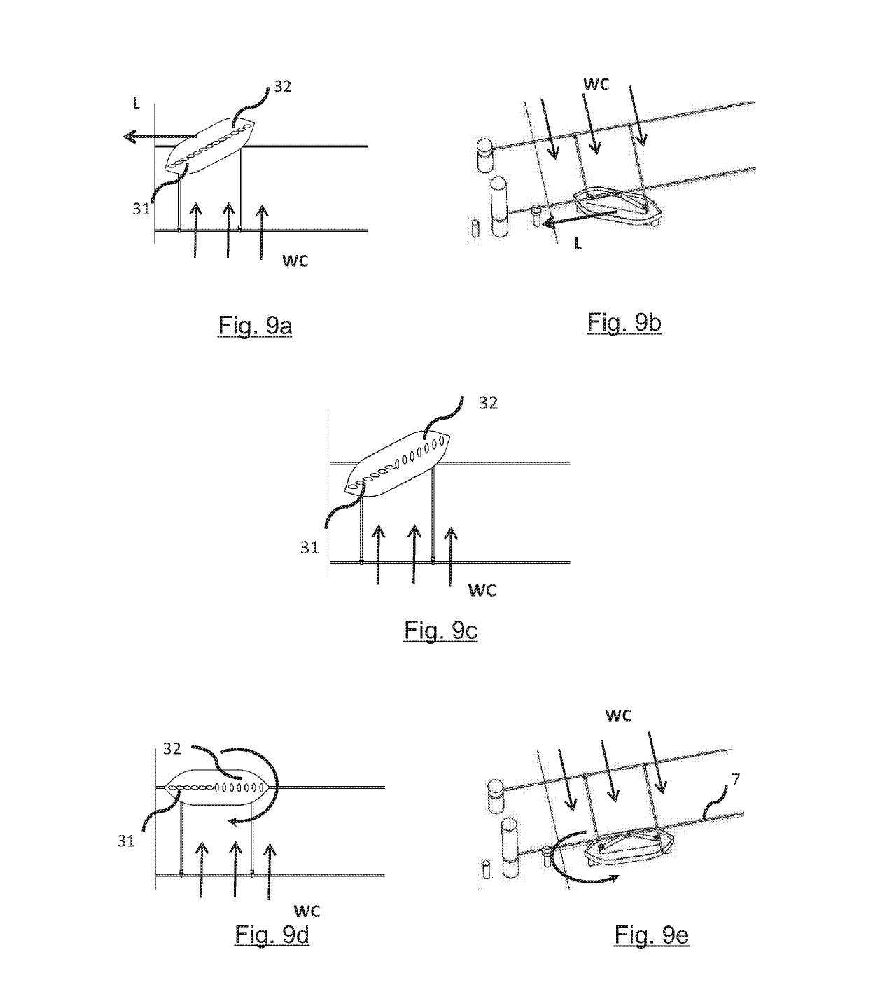

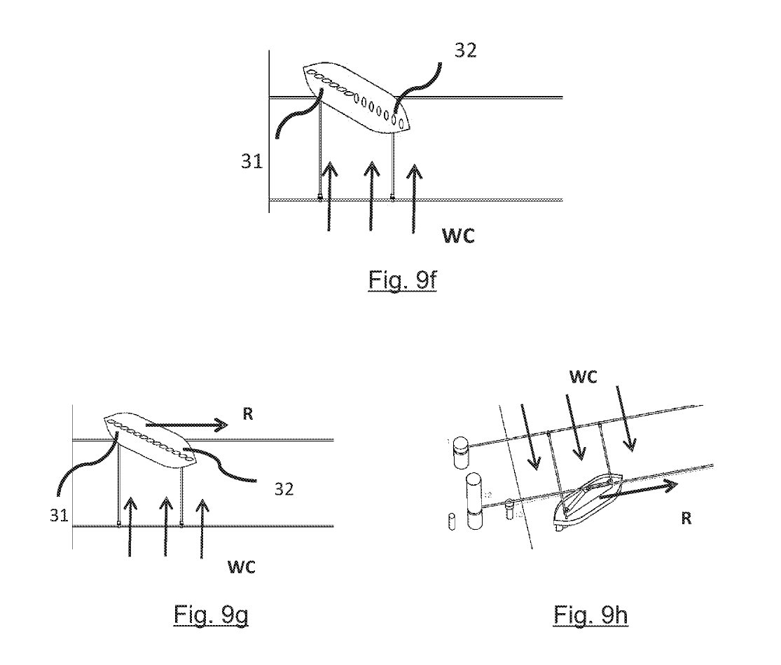

FIGS. 9a to 9h are schematic partial views of the vessel 1 of the first embodiment of the present invention, illustrating the sequence during the reorientation of the vessel 1 according the keels method. FIG. 9a is a bottom view of the vessel 1 moving on direction L (leftwards) reaching the end of the travel, with both the bow keels group 31 and the stern keels group 32 closed to transfer the force of the water current WC to the vessel 1. FIG. 9b is a perspective partial view of the vessel 1 at the same exact moment that FIG. 9a. FIG. 9c is a partial bottom view of the vessel 1 when it is stopped by means of a mechanical stopper at the end of leftwards travel and a keel mechanism makes the stern keels group 32 rotate each keel 12 on its rotation axis in order to be aligned with respect to the current, which is the neutral position. In this neutral position the keels 12 receive the minimal drag force from the water current. At the same time the bow keels group 31 remains closed receiving the drag force from the water current. Simultaneously to the reorientation of the keels 12, the locking mechanism of the handling bars 8,9 is released in order to allow this handling bars 8,9 move relative to the vessel 1, which permits the vessel 1 to rotate. FIG. 9d is a partial bottom view of the vessel 1 while it rotates around its pivoting axis. The rotation is achieved by means of a torque equals to the drag force applied to the bow keels group 31 and its distance respect to the pivoting axis. As the stern keels group 32 is not receiving any drag force, it allows the rotation of the vessel 1 around the pivoting axis. FIG. 9e is a perspective partial view of the vessel 1 at the same exact moment that FIG. 9d. The pivoting element 33 on the vessel 1 is articulated to the pivoting cable 7 and during the rotation of the vessel 1 it will hold all the force of the current transmitted to the vessel 1, since the locking mechanisms of the handling bars 8,9 remain open. FIG. 9f is a partial bottom view of the vessel 1 showing the moment it ends its rotation. At that moment the locking mechanism of the handling bars 8,9 is activated to fix the length of both handling bars 8,9, and simultaneously the keels mechanism makes the keels 12 of the bow keels group 31 to rotate each on its own axis, leaving their neutral position, aligning with the stern keels group 32. FIG. 9g and FIG. 9h show the same moment at which the already reoriented vessel 1 receives the lift force from the current on both bow keels group 31 and stern keels group 32 and starts its travel on direction R (rightwards). The reorienting sequence is repeated following the same procedure described on FIGS. 9a-9h when the vessel 1 reaches the rightwards end of travel, but in this case the assigned bow keels group 31 and stern keels group 32 are inverted. On that right end of travel reorientation the rotation movement of the vessel described on FIG. 9d become counterclockwise, the opposite direction that for the left end of travel reorientation.

FIG. 10 is perspective view of a second embodiment of the present invention showing the vessel 1 oriented with an angle respect to the current in order to move leftwards. The guiding system 2 is a single cable, specifically the pivoting cable 7, fixed on its ends to fixed posts 3 placed inside the riverbed or inland. Additionally, the second embodiment has another cable, a trailing cable 15 which is attached to the stern of the vessel 1 and is trailed by the movement of the vessel 1, producing a rotation on the pulley and flywheel system 35. There is a mechanic transmission element connected to the pulley and flywheel system 35 and the flywheel drives a power generator unit attached to it. The vessel 1 is linked to the pivoting cable 7 by either a first pulley mechanism 13 as disclosed above using pulleys as disclosed in FIGS. 5 and 6, or by an articulated sleeve which slips on the pivoting cable 7, which allow the vessel 1 to rotate around them at the pivoting axis, comprising a lock-unlock system which is locked during the travel of the vessel 1 maintaining the attack angle of the vessel 1, and unlocking to allow rotate once the vessel reaches the left stopper element 36 at the end of the travel. The first pulley mechanism 13 may also be used to generate electrical power with an electrical generator attached to it as explained above for the first embodiment. All the power generation systems can run independently or altogether. The trailing cable 15 is only tense on the training direction, for FIG. 10 corresponding to the section from the link with the vessel 1 to the right, keeping the opposite section without tension to allow the vessel 1 to rotate once it reaches the end of the travel. The left stopper element 36 may be attached to the pivoting cable 7 or to any other fixed element, which limits the travel of the vessel 1.

The reorienting of the vessel 1 for the second embodiment may be achieved by means of the keels method explained above for FIGS. 9a-9h, in this case without the procedures involving the handing bars 8,9 elements due to the absence of these handling bars 8,9 in this second embodiment.

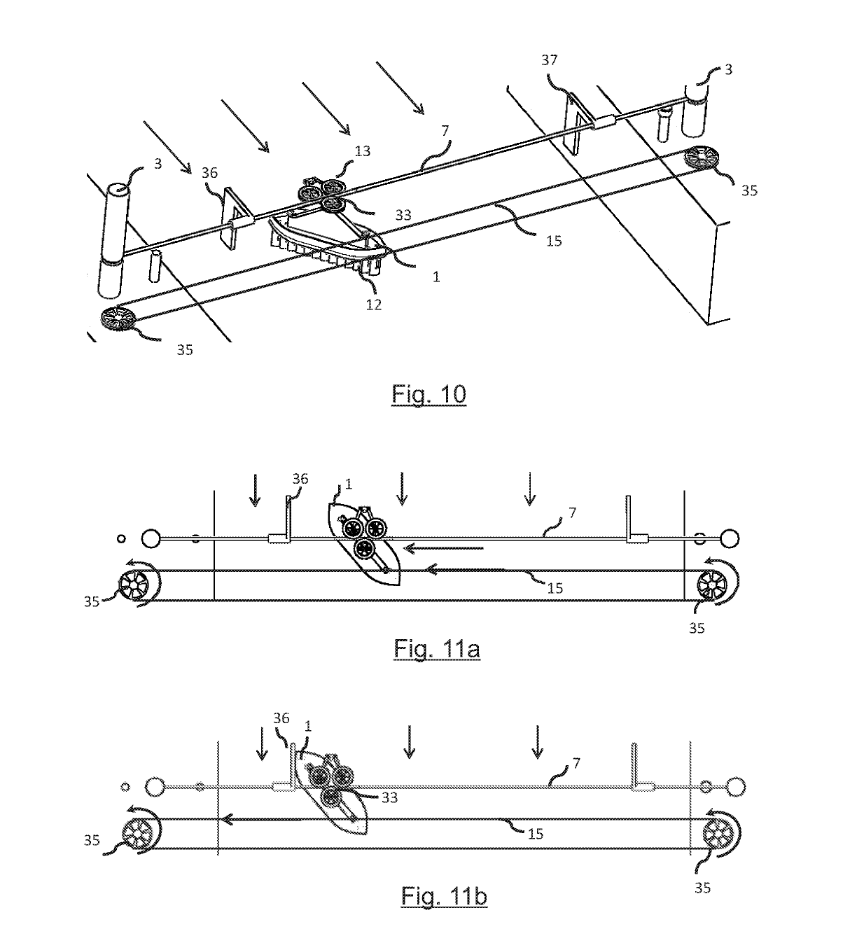

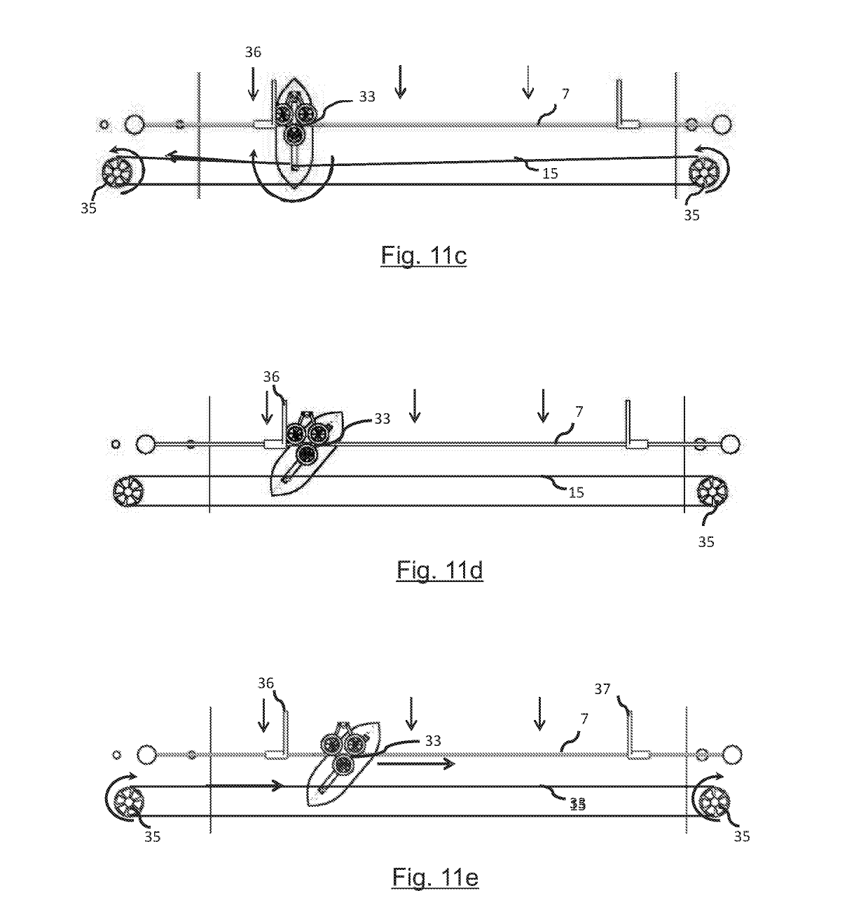

However, an alternative method to the keels method may be used to reorient the vessel 1. This is called inertia method and it is explained below regarding the sequence of FIGS. 11a-11e. FIG. 11a is a top view of the second embodiment of the present invention showing the vessel 1 traveling leftwards. The vessel 1 trails the trailing cable 15 which produces the rotation of the pulley and flywheel system 35 on the arrow direction. The flywheel accumulates energy during this travel movement. FIG. 11b is a top view of the second embodiment of the present invention showing the moment when the leading edge of the vessel bow makes contact with the left stopper element 36. That contact deactivates the locking mechanism of the pivoting element 33 which maintained the vessel 1 fixed to an attack angle and makes possible the vessel 1 to start rotating over its pivoting axis. The edge of the vessel 1 in contact with the left stopper 36 will have no lateral movement while the stern side of the vessel 1 will keep in motion being pushed by both the lifting force on the vessel 1 and the pulling effect of the trailing cable 15 which keeps moving because of the stored energy on the flywheel of the pulley and flywheel system 35. In order to minimize the resistance of the vessel 1 to rotate, the keels may rotate on its own axis to get oriented on the direction of the rotation of the vessel, facing the minimal area on the direction of the movement of the vessel stern. FIG. 11c shows the vessel 1 during its rotation with the stern side still being pulled by the trailing cable 15 due to the energy stored on the flywheel of the pulley and flywheel system 35. The locking mechanism on the pivoting element 33 is open during this process allowing the rotation of the vessel 1. FIG. 11d shows the moment when the vessel 1 reaches the end of the rotation. This limit is fixed by any external element to the vessel 1 or inside it, producing a self-locking of the locking mechanism on the pivoting element 33 at that point, fixing the position of the vessel 1 to a new attack angle with reference to the current. At that moment the trailing cable 15 and the pulley and flywheel system 35 are stopped as the vessel 1 stops rotating. At this moment the keels may rotate on their own axes to get fixed at the proper attack angle to start the movement rightwards. FIG. 11e shows the moment when the vessel 1 starts traveling rightwards due to the lift force of the current. The movement of the vessel 1 starts pulling the trailing cable 15 which makes rotate the pulley and flywheel system 35 in the direction of the arrow, starting the rightwards traveling which will end once the leading edge of the bow of the vessel 1 touches the right stopper element 37 repeating the process disclosed above.

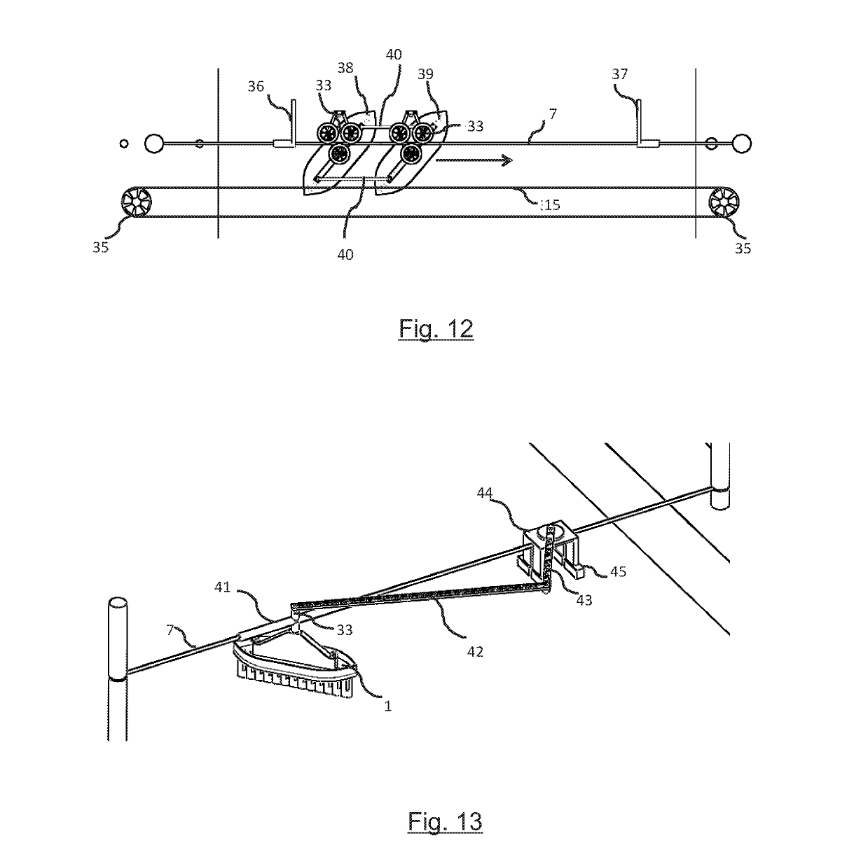

According the second embodiment of the invention, the vessel 1 is attached to the guiding system only through the pivoting element 33, which may limit the amount of the force endured by the mechanism while the vessel 1 receives the lift force of the water current. As the amount of the lift force is proportional to the area of the vessel 1 facing the water current, the limit of the force also implies a limit on the vessel 1 size. So, in order to obtain the maximum power from the water current, more than one vessel 1 may be arranged in parallel, as shown in FIG. 12. The first additional vessel 38 and the second additional vessel 39 travel rightwards, and are joined to the trailing cable 15 on their stern side, and each one have an articulated joint as the pivoting element 33, which allow them to link to either a pulley system or a slipping sleeve, any of them running on a same pivoting cable 7. The vessels 38,39 are joined together through first articulated bars 40, one of them on the bow side and the other on the stern side. The two bars 40 keep the vessel 38,39 parallel all the time, allowing the reorientation cause only one of them touches their respective stopper, left stopper 36 for left vessel 38 and right stopper 37 for right vessel 39. The invention may be arranged with as many vessels as the space permits. The more the vessels the higher the power obtained at the power generation unit.

FIG. 13 is a general perspective view of a third embodiment of the present invention, showing the vessel 1 with an angle of attack fixed respect to the water current, traveling rightwards. The vessel 1 reorients itself once it reaches the end of travel, inverting the direction of travel. The guiding system of the third embodiment is the same that the one of the second embodiment, having a pivoting cable 7 with either a pulley system or a slipping sleeve 41 articulated to the vessel 1 on its pivoting element 33 allowing it to run along the pivoting cable 7. There is a locking mechanism on the pivoting element 33 that locks the rotation of the vessel 1 over its pivoting axis, and is unlocked once the vessel 1 reaches the end of travel on both directions. The main difference of this third embodiment respect to the first and second embodiments refers to the system that transforms the travel of the vessel into a spinning shaft which drives the power generation unit, this is the transformation system. In this third embodiment, the transformation system consists of a rod and crank mechanism where the rod bar 42 is articulated in one of its ends to either the vessel 1 or the sleeve 41 and its other end is articulated to the crank bar 43. As the vessel 1 travels on one direction it trails the rod bar 42 which in turn makes the crank bar 43 to rotate. The rotational movement of the crank drives the fifth electric power generator unit 44 which comprises in turn a spinning shaft, a flywheel, a mechanical transmission and an electrical generator. This fifth electric power generator unit 44 is fixed to the pivoting cable 7, with no relative movement respect to it, and is provided with a floating element 45 to prevent that its weight be supported directly by the pivoting cable 7. The rotation of the spindle shaft is unidirectional no matter the direction of travel of the vessel 1, which is an advantage respect to the other embodiments, because it saves the use of a mechanical inverter to drive the electrical generator.

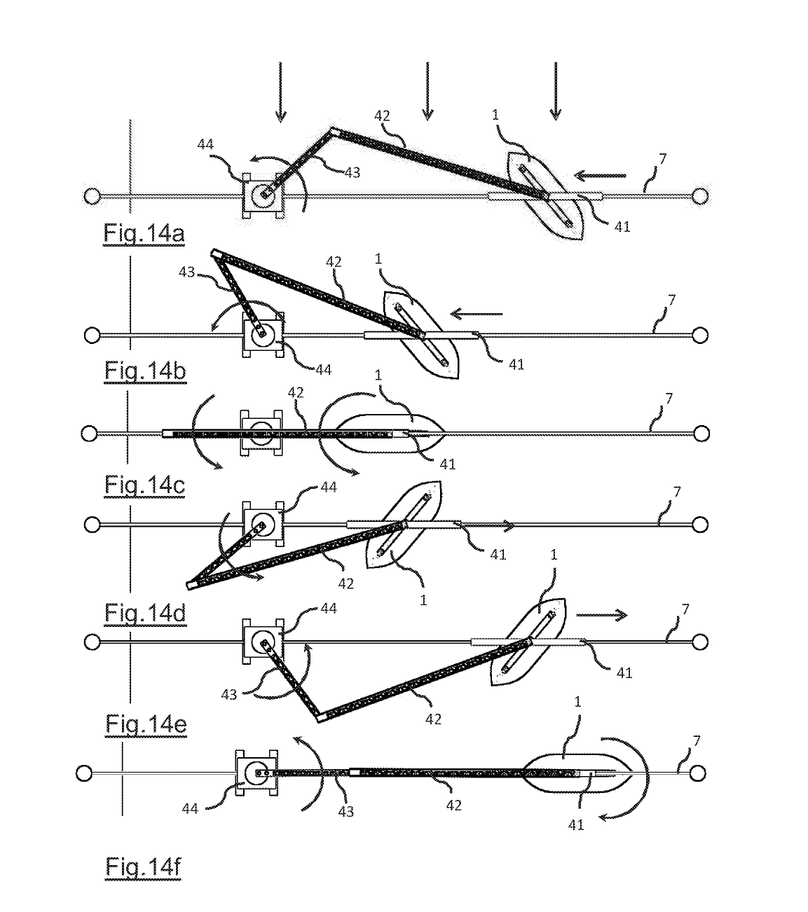

FIGS. 14a-14f are top views of the third embodiment of the present invention showing the sequence of the system during operation. FIG. 14a shows the vessel element 1 traveling leftwards, pushing the articulated rod element 42, which at the same time makes rotate the crank element 43 linked to it. The crank element 43 transmits the rotation to the spindle shaft attached to the flywheel and the electric generator, all of them belonging to the fifth electric power generator unit 44. The vessel 1 continues its leftwards travel as shown in FIG. 14b until it get close to the moment described on FIG. 14c, where both rod element 42 and crank element 43 are aligned one on top of the other. This moment is the end of the travel, in which the locking mechanism located on the pivoting element 33 of the vessel 1 is released to allow the vessel 1 to rotate over its pivoting axis 33, thus the vessel 1 reorienting its attack angle in order to invert the direction of the travel. In the case of FIGS. 14a-14f the reorientation method used is the keels method, where the stern keels group 32 rotate over its own axis getting aligned with the water current direction, in order to receive zero lift force, while the bow keels group 31 remain on the same position, in such a way that the vessel 1 rotates about its pivoting axis due to the torque produced by the lift force received only on the bow keels group 31. The flywheel element in the fifth electric power generator unit 44 makes the vessel 1 never get stuck at the end of travel, keeping it in movement even during the reorientation. Once the vessel 1 reorients, the keels mechanism rotates back the stern keels group 32 to its original position, and the locking mechanism at the pivoting element 33 is activated back to maintain the new set angle of attack of the vessel 1 to make it move rightwards. Continuing with FIG. 14, the already reoriented vessel 1 starts its movement rightwards pulling the rod element 42 which maintains in movement the flywheel in the fifth electric power generation unit 44. The reorienting process of the vessel 1 occurs then when it reaches the right end of travel as shown in FIG. 14f, starting the cycle all over again.

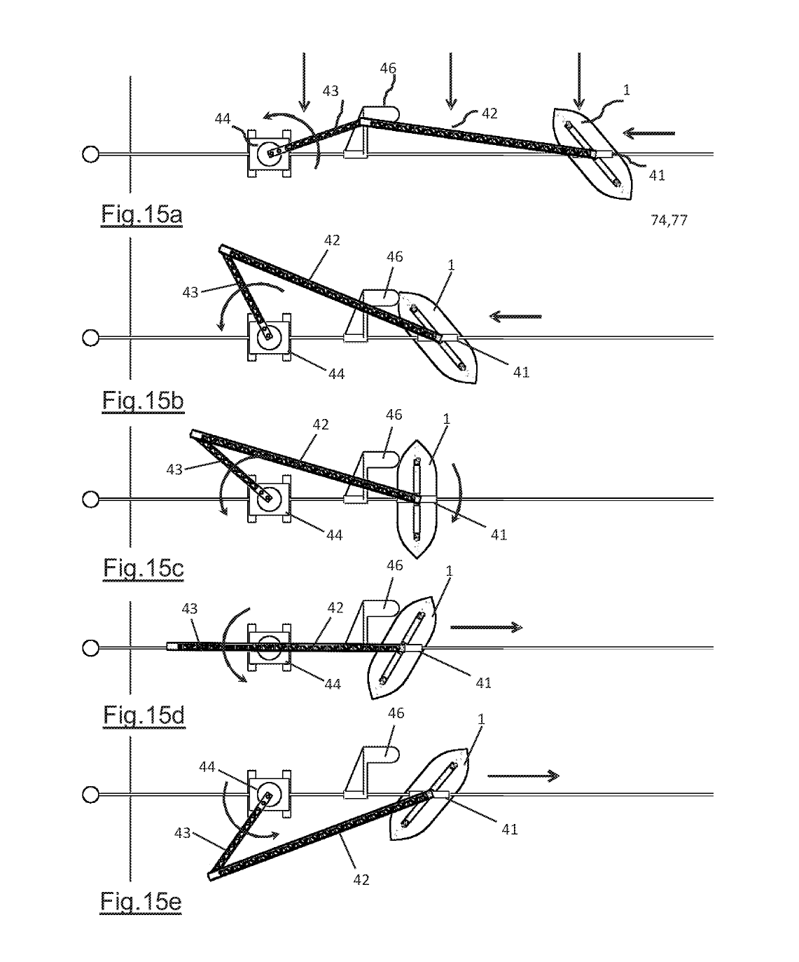

FIGS. 15a-15e are a sequence of top views of the third embodiment showing the reorientation of the vessel 1 which moves leftwards on FIG. 15a according the inertia method. According the inertia method a fixed stopper element 46 is placed on the pivoting cable 7 close to each of the end of travel of the vessel 1, in such a manner that it makes contact only with the leading edge to the vessels bow as shown in FIG. 15b, obstructing its leftwards movement, while the rest of the vessel 1 continues moving on the same direction due to the force transmitted by the rod bar 42 linked to the slipping sleeve 41, producing the rotation of the vessel 1 about its pivoting axis as shown in FIG. 15c. The force of the rod bar 42 comes from the rotational energy accumulated by the flywheel on the fifth electric power generation unit 44, and it is transmitted to the rod bar 42 through the crank bar 43. To allow the rotation of the vessel 1 about its pivoting axis, the locking mechanism located on the pivoting element 33 must be released once the vessel 1 makes contact with the fixed stopper 46. Once the vessel 1 reach the new attack angle at the end of the travel, as shown in FIG. 15d, the locking mechanism is activated again and the vessel 1 starts its rightwards movement as shown in FIG. 15e.

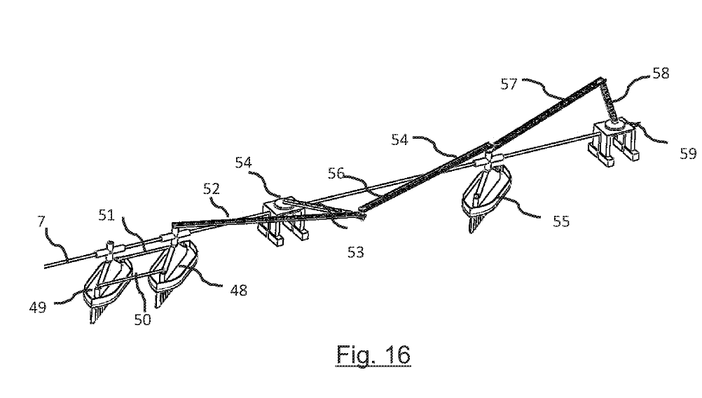

FIG. 16 shows a perspective view of an array of several modules of the third embodiment interconnected using three typical interconnection modes, all of them using a single pivoting cable 7. The first interconnection mode refers to connect multiple vessel units in parallel, in FIG. 16 represented by third additional vessel 48 and fourth additional vessel 49, in such a way that the overall moving force of the vessels 48,49 together moves a single rod element 52. The vessels 48,49 are linked together through first articulated bar 50 and second articulated bar 51, which makes that both vessels 48,49 move and turn always in parallel. The force of both vessels 48,49 is transmitted through the single rod element 52 and converted in a rotational movement on the spindle shaft of the sixth electric power generator unit 54 by the single crank element 53. The second interconnection mode refers to drive a sixth electric power generator unit 54 by means of two vessels 48,55 connected in opposite directions through the rod element 52 and the additional rod element 56 respectively, articulated to a same crank element 53. This connection helps to transmit twice the power of a single vessel into a same crank, improving also the continuity on the movement of the system. The third interconnection mode refers to use a single vessel unit, the fifth additional vessel 55, to drive two separated electric power generator units 54,59, by joining two different rod elements 56,57 respectively to the fifth additional vessel 55 or to its sleeve element. These connection modes allow mechanically connecting several power generation units in parallel all over the same pivoting cable 7, receiving the combined force from several traveling vessels. The three connection modes disclosed above can be arranged in different manners, varying the number of modules involved and using the three different connection modes as required. This modular arrangement allows to easily increasing the installed power generation capacity of a location just by adding more modules or interconnecting the existing ones, using the same components.

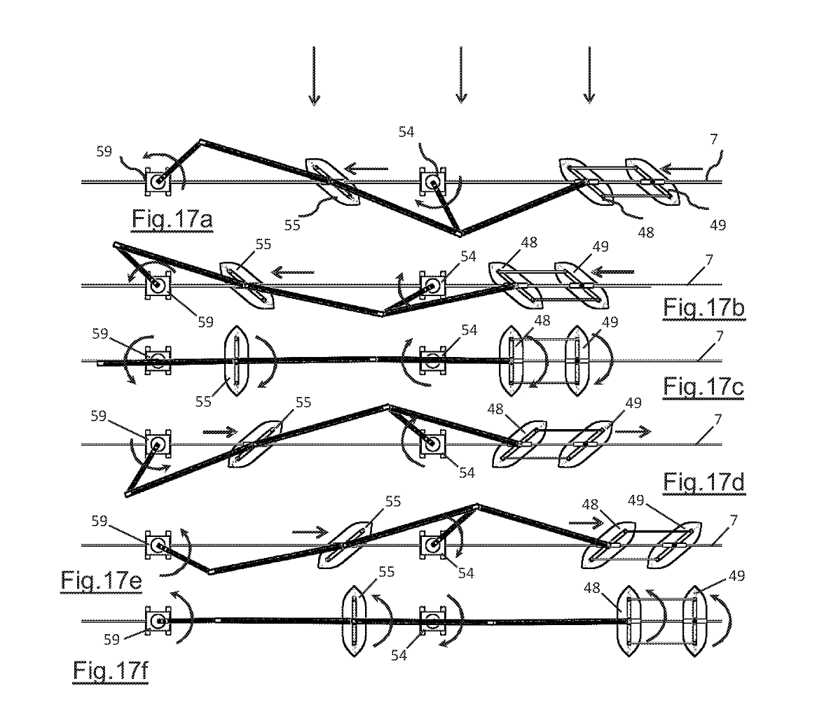

FIGS. 17a-17f are a sequence of top views of the arrangement of the modules of the third embodiment interconnected on a single pivoting cable 7 as shown in FIG. 16, showing one operating cycle of the system. FIG. 17a shows the vessels 48, 49,55 traveling leftwards producing a rotational movement clockwise on the spindle shaft of the sixth electric power generator unit 54 and a counterclockwise movement on the seventh electric power generator unit 59. Both power generator units 54,59 have a flywheel unit which is charged during the travel of the vessels 48,49,55. FIG. 17b shows the moment when the vessels 48,49,55 approach to the right end of travel, then the locking mechanism on each vessel is unlocked in order to allow the reorientation of each vessel as they reach the end of travel. FIG. 17c shows the rotation of the vessels 48,49,55 following the inertia method, which implies that fifth additional vessel 55 and third additional vessel 48 hit against a fixed stopper element each of them, as shown in FIGS. 15a-15 e, with the leading edge of its bow hull, producing the rotation of each vessel about its pivoting axis, as shown in FIG. 17c. The three vessels 48,49,55 move and rotate at the same time which implies that all the travels are the same length and all of the rods elements are equally sized as well as all of the crank elements are too. FIG. 17d shows the vessels 48,49,55 reoriented to its new attack angle starting their rightwards travel. The flywheels located on the power generator units 54,59 provide the energy to maintain a continuous movement of the system during the reorientation and the travel, in case that one of the vessel tends to move slower than the others. FIG. 17e shows the vessels 48,49,50 approaching to the right end of travel, on the instant when they hit against the fixed stoppers element, to initiate the reorienting rotation. At that point the pivoting locking mechanism is released to allow the vessel rotation. FIG. 17f shows the vessels 48, 49,55 during their rotation.

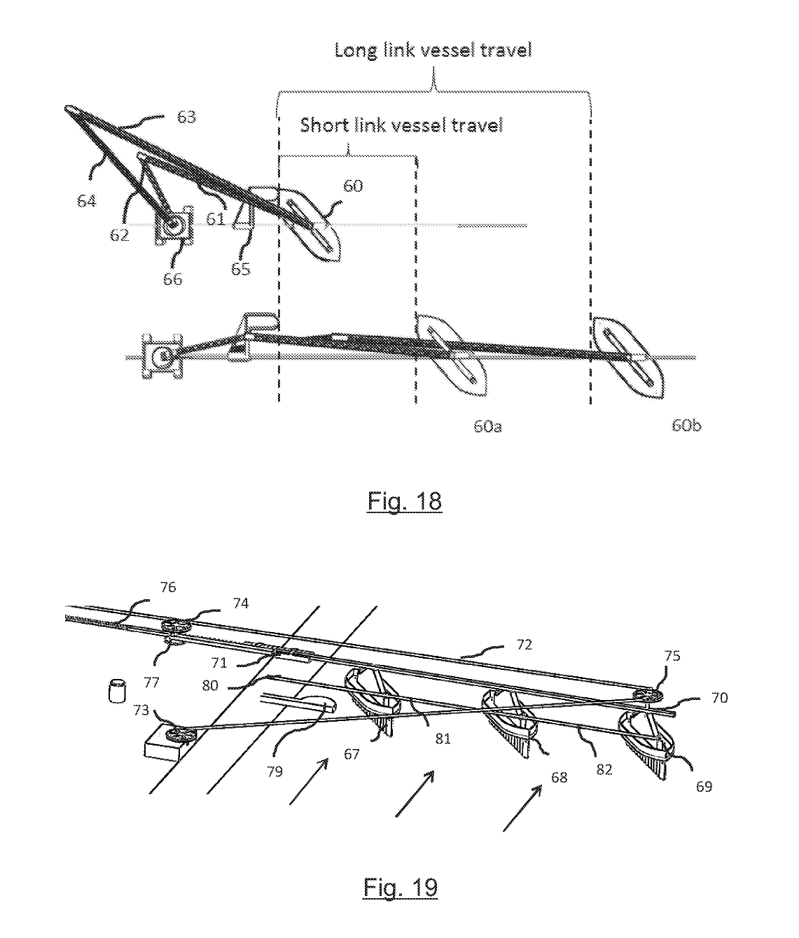

FIG. 18 is as top view of the third embodiment showing two overlapping images of the travel of a sixth additional vessel 60, comparing the length of travel when using short rod element 61 and short crank element 62, and a longer rod element 63 and a longer crank element 64 (position 60a corresponds to short linkage and 60b corresponds to long linkage) by means of adjustable length elements. As shown in FIG. 18, the longer the crank 64 provides a proportionally larger travel length according to the following relation:

Travel=(crank length+rod length)−(rod length−crank length)

As it can be seen, the rod length does not affect the travel length but is necessarily adjusted to the increment of the crank length to keep the distance from the end of travel to the eighth electric power generator unit 66. The larger the travel length the more continuous and steady the operation, and the torque transmitted to the eighth electric power generator unit 66 is directly proportional to the length of the crank element, reasons why it is desirable having a crank as large as possible. The problem with large rod and crank elements is related with mechanical issues, adaptation of the device to any river or channel location and capability of adjust the inertia of the system to the obtained lift force on the vessel, reasons why having adjustable length rod and crank is an advantage of the present invention. The adjustment in length of the elements can be achieved either by telescopic means, or by connecting additional link modules to the existing elements, by replacing the link elements with different size ones, by fold-unfold procedures or by any other mean implying modifying the length of one of the elements or both rod and crank.

FIG. 19 shows a perspective view of a fourth embodiment of the present invention, which comprises a series of traveling vessels attached to a moveable guiding system which changes its relative length respect to the shore line. The main difference of this fourth embodiment respect to the other embodiments of the present invention is that this fourth embodiment has only one fixed anchorage for the guiding system, preferably onshore, offering an advantage because of not requiring nor fixed posts or anchorages on the riverbed or between opposite shores in a water channel or river, which could limit the applicability of the present invention in navigable rivers or channels because of the obstruction in the line of navigation. FIG. 19 shows three traveling vessels 67,68,69 with their attack angle oriented to move rightwards, all of them articulated to a sliding bar 70 through their pivoting element in order to allow the reorientation of the vessels 67,68,69 once the bar reaches its end of travel. The movement of the system is provided by the lifting force of the water current on the vessels 67,68,69, and they trail the sliding bar 70 rightwards and leftwards. The sliding bar 70 is restricted to move linearly due to the guiding element 71 anchored to the shoreline which allows the sliding bar to pass thru with a minimal friction. A tensing cable 72 which provides the system the resistance to avoid being dragged by the water current. The tensing cable 72 rolls and unrolls on two reel wheels 73,74, and passes through a fifth pulley 75, producing a reaction force on the sliding bar 70 opposite to the water current direction. The sliding bar 70 has a toothed element 76 on its land side, which works transmitting its lineal movement to the power generator unit 77 through a rack and pinion mechanism, which drives a spindle shaft with the flywheel disc attached to it. The rotation of the spindle shaft drives the ninth electric power generator unit 77. The reorientation of the vessels 67,68,69 may occur by means of the keels method or the inertia method. In both cases there are a fixed stopper element 79 and a trailing cable 80 which release or activate the locking mechanism on the pivoting axis of the vessels 67,68,69 at each end of travel. The first bar 81 is an articulated link which makes the vessels 67,68 move always parallel to each other, the same as the second bar 82 does with the vessels 68,69. In this form, the signal to rotate may be transmitted only to the moving leading vessel and the other will follow. The system in FIG. 19 is represented by three vessels 67,68,69, but the number of vessels used in this application could be from a single unit up to a no limited number of vessels.

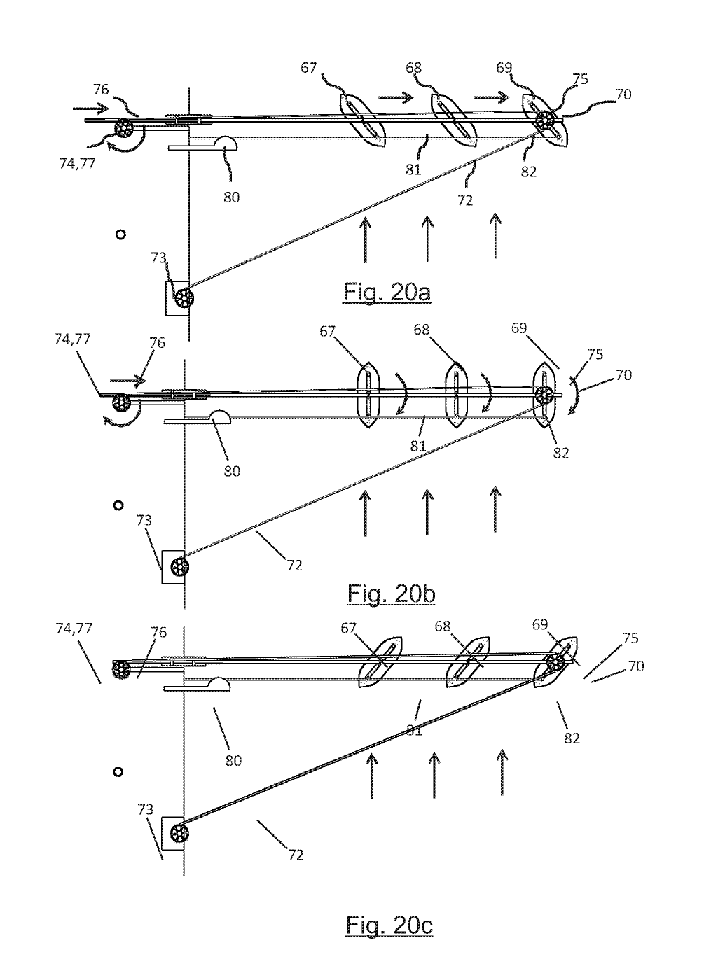

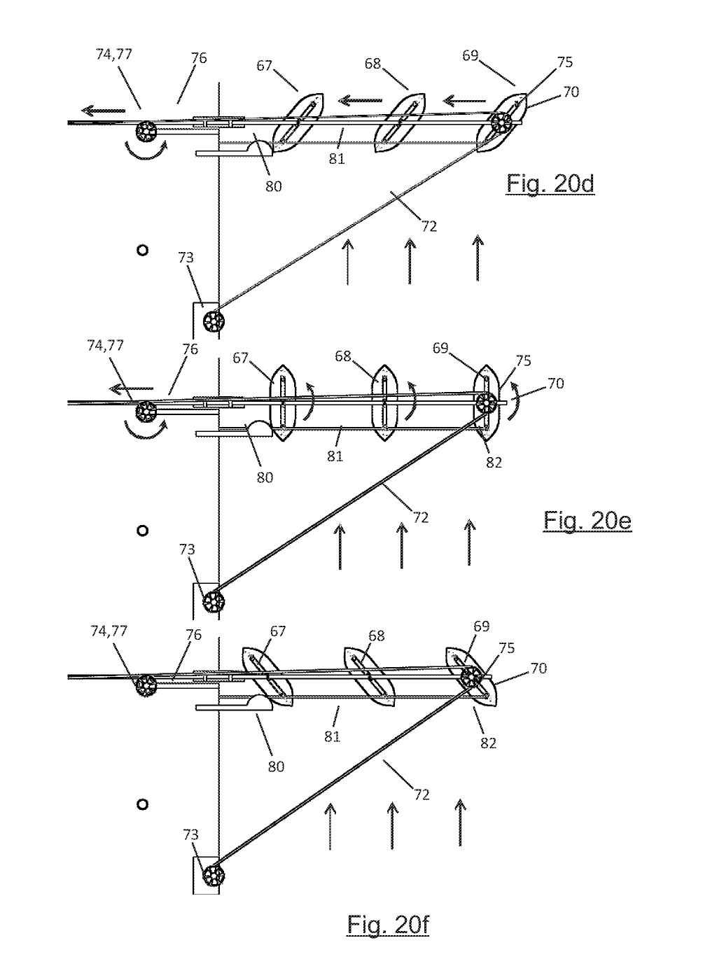

FIGS. 20a-20f are a sequence of top views of the fourth embodiment showing the cycle of the device, with the reorienting procedure using the inertia method. FIG. 20a shows the vessels 67,68,69 moving rightwards, trailing the sliding bar 70, which transmits the movement to the ninth electric power generator unit 77 making it rotate its spindle shaft, which makes to rotate also the flywheel attached to it. The tensing cable is unwinding from the reel wheel 74 allowing the sliding bar 70 to advance. Once the trailing cable 80 gets tense it makes the bow part of the vessels hull to stop, the locking mechanism in charge of maintaining the vessel to its attack angle is released, while the sliding bar 70 still moves because of the inertia of the flying wheel which makes each vessel 67,68,69 rotates about its own pivoting axis as shown in FIG. 20b. Once the rotation of the vessels 67,68,69 reach the attack angle to move on the opposite direction the locking mechanism on the pivoting elements reactivates. Once the vessels 67,68,69 are reoriented the system is stopped as shown in FIG. 20c. FIG. 20d shows the vessels 67,68,69 and the sliding bar 70 traveling leftwards. The tensing cable 72 is kept tense because the reel wheel 74 where it is winded rotates with the sliding bar 70 movement due to the rack and pinion mechanism. Once the vessel 67 leading edge of the bow hull reaches the fixed stopper 80 it gets stopped, while the sliding bar 70 continue advancing because of the inertia of the flying wheel attached to the ninth electric power generator unit 77, releasing the locking mechanism on the pivoting element, making the vessel 67 to rotate about its pivoting axis as shown in FIG. 20e. The rotation of the vessel 67 is transmitted to the other two vessels 68,69 due to the first bar 81 and the second bar 82. Once the vessels 67,68,69 reach the new attack angle, the locking mechanism on each pivoting element is locked back and at that moment the whole system stops moving to invert its moving direction as shown in FIG. 20f. The sliding bar 70 may be a single piece or a bar composed of several modules, which allows to increase the length of travel or to let the vessels 67,68,69 operate far from the riversides where deeper, faster or more uniform water current is.

An alternative to the single sliding bar 70 is the articulated linkage shown in FIG. 21, which diminishes the running length of the rack bar of the toothed element 76 in FIG. 19 to a fraction while allowing increasing the length travel of the vessels 67,68,69.

So FIG. 21 is a general perspective view of the fourth embodiment of the present invention showing an alternative for the moving guiding system using a sliding bar 70 above explained. The single sliding bar 70 of FIG. 19 is replaced by an articulated extensible-compressible linkage 83 similar in shape to the mechanism popularly known as “lazy tong”, which has a number of pairs of equal size links called arms 84, being articulated in the middle portion of its total length to its paired arm through a planar articulation 85, and at each of its ends with the arms 84 of the adjacent pairs forming a hinge articulation 86. The vessels 67,68,69 are joined through its pivoting element 33 to the planar articulations 85 of the articulated extensible-compressible linkage 83. When the vessels 67,68,69 move due to the action of the water current, the articulated extensible-compressible linkage 83 extends or contracts depending of the moving direction of the vessels 67,68,69. FIG. 21 shows the vessels 67,68,69 having their angle of attack oriented to move rightwards, which would make the articulated extensible-compressible linkage 83 to extend. The articulated extensible-compressible linkage 83 is anchored and guided in land portion by the fixed guide 87 to ensure it extends or contracts only in perpendicular direction to the water current. To avoid the articulated extensible-compressible linkage 83 to be dragged by the water current, a tensing cable 72 is provided, which pulls the articulated extensible-compressible linkage 83 from its fifth pulley 75. The tension of the tensing cable 72 comes from the winding and unwinding of it over the second reel 74 and the first reel 73. There are three different ways to convert the movement of the vessels 67,68,69 into useful energy.

FIG. 21 shows a first way to convert the movement of the vessels 67,68,69 into useful energy, and it is achieved by the turning of a spindle shaft which is connected to a flywheel, to the tenth electric power generator unit 78 and to a pinion. The spindle shaft rotates due to a rack and pinion mechanism of a tooth element 76, where the rack is connected to an additional sliding bar 88, which is joined to one of the planar articulations 85 and moves linearly guided by the fixed guide 87. The movement of the additional sliding bar 88 is achieved by means of the displacement of the planar articulation 85 to which it is joined, due to the extension or contraction of the articulated extensible-compressible linkage 83.

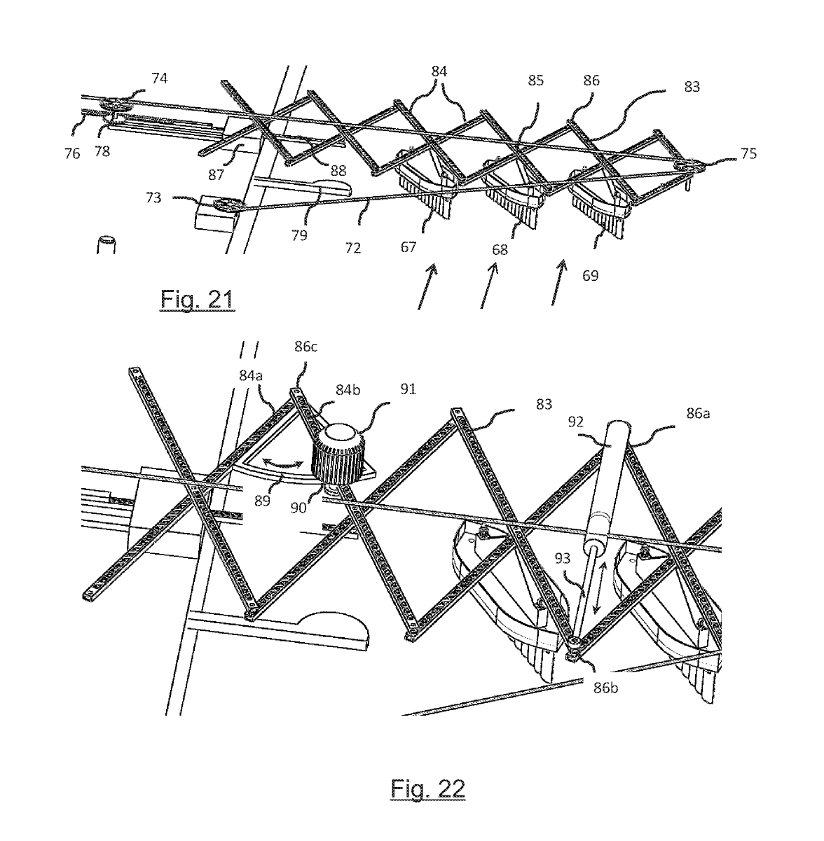

FIG. 22 is a partial perspective view of the fourth embodiment with the guiding system shown in FIG. 21, which has an articulated extensible-compressible linkage 83. In this case, a second way to convert the movement of the vessels 67,68,69 into useful energy refers to a circular rack 89 rigidly attached to a first arm 84a of the articulated extensible-compressible linkage 83 which moves relative to its gear pinion 90, which is attached to an eleventh electric power generator unit 91 rigidly attached to a second arm 84b. When the travel of the vessels 67,68,69 provides the elongation or contraction of the articulated extensible-compressible linkage 83, both arms 84a,84b rotate about third articulation 86c increasing or decreasing the angle between them. The change of the angle causes the rotation of the gear pinion 90 about the circular rack 89, driving the eleventh electric power generator unit 91. As the arms 84a and 84b will alternate between getting closer and separating depending if the articulated extensible-compressible linkage 83 is contracting or elongating, the relative movement will produce inverse spinning in the gear pinion 90 in each case. For this reason, the eleventh electric power generator unit 91 is provided with a single direction rotation transmission which make the input of the power generator will always be of the same direction no matter the rotational direction of the gear pinion 90. FIG. 22 shows only one circular rack 89 and gear pinion 90 with an eleventh electric power generator unit 91, but several of these systems could be placed, specifically as much as the number of articulations of the total linkage 83.

A third way to convert the movement of the vessels 67,68,69 into useful energy according to the fourth embodiment is also shown in FIG. 22 and it has a pumping system where a piston rod 93 is joined to the second articulation 86b, while the piston chamber 92 is joined to the first articulation 86a. Both first articulation 86a and second articulation 86b are in opposite sides of the diagonal of one of the rhombus of the articulated extensible-compressible linkage 83. As the articulated extensible-compressible linkage 83 extends or contracts due to the movement of the vessels 67,68,69, the first articulation 86a and second articulation 86b change their relative distance making the piston rod 93 to move in or move out relative to the piston chamber 92. The change in the closing volume formed between the inner walls of the piston chamber 92 and the piston head 93 is used to pump a fluid, mainly the water from the water channel or river, but not limited to it. This pressurized fluid is moved through a pipe or hose system down to a fluid pressure accumulator or directly onto a mechanical power generator, mainly a turbine, for instance a Pelton-type turbine. The rotation of the turbine may be used to drive an electrical power generator or any other mechanical device. As the articulated extensible-compressible linkage 83 will alternatively contract and elongate, a double effect piston pump will be used in order to work pumping fluid in both directions, while the piston rod 93 goes in and when it goes out. When the inner volume formed between the piston head and the inner chamber 92 expands the fluid is suctioned by means of the vacuum pressure generated, and when the movement of the piston rod 93 inverts the direction, the volume is reduced, making the fluid being pumped out of the chamber 92. To make the system operate as intended it is required two fluid inlets and two outlets, provided with check or anti-return valves on each of them to avoid the pressurized fluid exits the pump through the inlet tube as well as to avoid the already pumped fluid be sucked again through the same outlet tube.

The three ways disclosed above to convert the movement of the vessels 67,68,69 into useful energy can be applied simultaneously or independently, and in the case of the second and third ways the number of power generator units or pumps installed will depend on the total inertia of the device and the number of vessels installed, taking into account that the total propelling force of the water current on the vessels must be higher than the force required to move the articulated linkage with all the working power generation units installed. Since the water channels and rivers may vary their flow and speed due to seasonal reasons, all of the three ways disclosed above are able to easily mechanically disengage or run in empty mode (it means without pressurizing in the case of the pumps) in order to not create a load against the movement of the linkage, allowing the system operate with low energy water currents even when a number of power generation systems are installed on the device but are not active. The user can activate them back once the water current increases its energy.

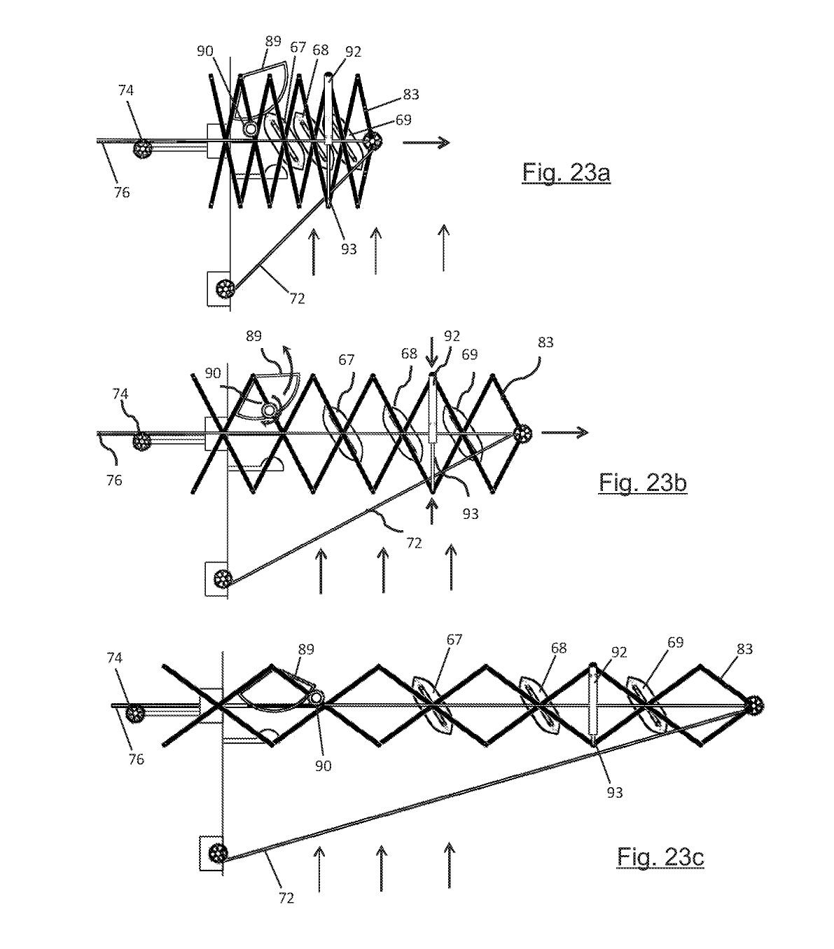

FIGS. 23a-23c are top views of the fourth embodiment of the present invention showing a sequence of one travel of the vessels 67,68,69 with the articulated extensible-compressible linkage 83 moving from its most contracted stage in FIG. 23a up to its most extended stage in FIG. 23c passing through an intermediate stage shown in FIG. 23b. FIG. 23a shows the instant when the vessels 67,68,69 start their travel leftwards (considering the above definition where left means the left hand of a viewer placed on the vessel looking the water current upstream) after they reoriented by either the keels method or the inertia method. At that moment the articulated extensible-compressible linkage 83 is on its more contracted position, with the rack bar of the tooth element 76 with the most of its length in land starting to move leftwards (right side of the FIGS. 23a to 23c), the circular rack 89 starting its clockwise movement, the piston pump with their piston rod 93 moving inwards the piston chamber 92. The tensing cable 72 is at its shortest length, having the most of it winded on the second reel wheel 74. As the rack bar of the tooth element 76 moves leftwards, the second reel wheel 74 rotates engaged to it unwinding the tensing cable 72. FIG. 23c shows the end of travel of the vessels 67,68,69 when the articulated extensible-compressible linkage 83 reach its largest length. At that point the vessels 67,68,69 start their reorientation by either the keels method or the inertia method, rotating about its pivoting axis. The locking mechanism on the pivoting element had been previously released. At that moment, the rack bar of the tooth element 76 and the circular rack 89 reach their end and the piston pump is at its minimal length, with the piston rod 93 all the way inside the piston chamber 92.

In order to reduce the inertia of the articulated linkage of the fourth embodiment of the present invention, the individual links of the linkage must be the lightest possible, but at the same time stiff enough to transform the motion of the vessels into a displacement of the linkage, with a minimum deformation, which would mean lost or not desirable accumulation of energy. To achieve this goal, the proposed links are beams forming a preferably made of aluminum. Considering the use of this solution in remote areas, it is also proposed the use of bamboo poles for the linkages, adding the required articulated joints by adjustable additional elements attachable to the poles. This could represent a lower cost and sustainable solution for certain rural villages around the tropical areas.

Besides the main use of the fourth embodiment of the present invention as power generation, there are four different additional applications in which it may be used. The first additional application of the fourth embodiment of the present invention is working as a flexible docking structure to allow the anchorage of elements in the water current without requiring any foundation or post on the riverbed, with the capability of moving the position of such elements in different places of the water current due to the mobility of the structure. FIG. 24 is a top view of two separated fourth embodiment devices 95 having floating vessels articulated to a guided sliding bar, with a tensing cable with all the elements disclosed above and shown in FIG. 19, which are oriented in parallel, preferably perpendicular to the water current but not limited to it, with the sliding bars extended at a non-specified position to allow the establishment of generation devices 96 in the water current by means of cables or bars 97 attached to both sliding bars of the devices 95. The power generation devices may work in a static position on the water current, keeping both devices 95 stopped, or they can work while both devices 95 are traveling in alternative movement as disclosed above and shown in FIGS. 20a-20f. The power generation device 96 refers to any kind of mechanical device which transforms the energy of the water current into any displacement or rotation of components which may drive any electrical generator or other mechanical device as pumps, mixers or any artefact or equipment requiring mechanical power to operate. The device 95 can stand still at any extension by adjusting the attack angle of the vessels to a moving away (from the river side) position, as shown in FIG. 24 while keeping the tensing cables 72 unable to unreel, not requiring special brakes or additional locking mechanism for the device than the already explained, taking into account that any other locking mechanism would increase the stability of the system.

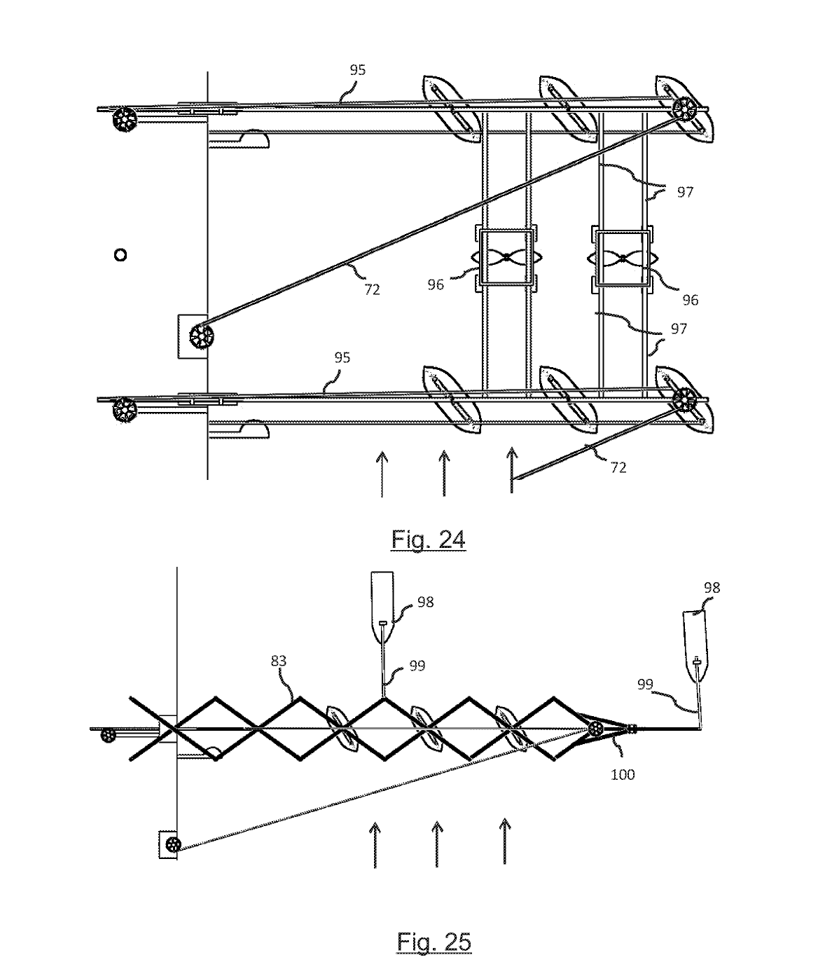

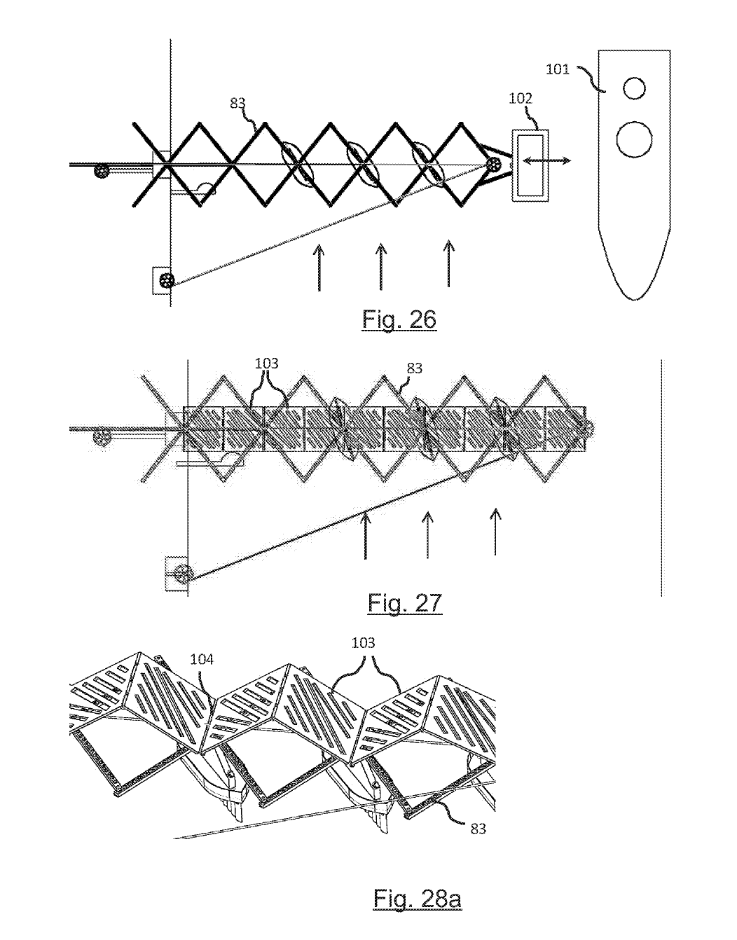

The second additional non-power generation application of the fourth embodiment of the present invention refers to the docking capability, allowing a single device to work as a river harbour to anchor boats or any other transporting device, with the advantage of being easily retracted or taken away from the navigation line on the water channel or river. FIG. 25 is a top view of the fourth embodiment of the present invention using an articulated linkage 83 as shown in FIG. 21, which is used as a harbour for small boats 98, attached by means of cables or ropes 99. The change in length of the linkage structure makes it a valuable solution to adapt the size of the structure to the quantity of boats, being more contracted as the number of boats is smaller. The controlled travel of the vessels allows the extension and contraction of the articulated linkage, which allows in turn the movement of the boats closer or far away from the riverside, which is important when the water level rises or lowers because of seasonal changes in the water channel or river. Additional links 100 on the leading edge of the linkage can be added to increase the capacity of the structure or to adapt it to special requirements.

The third additional non-power generation application of the fourth embodiment of the present invention refers to cargo or passenger transport, from the river side where the device is anchored up to any object located in the river, like any boat or ship, or like a bridge from one side of the river to the opposite river side. FIG. 26 is a top view of the fourth embodiment of the present invention showing the articulated linkage 83 as shown on FIG. 21, with a cargo platform 102 attached to it, approaching a ship 101 anchored on the riverbed, allowing the transport of passengers or cargo between one shore of the river where the device is anchored and the ship in the river. The main advantage of the device working on this application is that the energy required to expand or contract the bridge comes from the water current, as well as the flexibility of the linkage to reach spots located at different distances from the shore line, which allow the ship in the river to anchorage at the most convenient place, and not interfering permanently on the navigation line of the river, all of it without requiring any foundation or fixed structure on the riverbed.

The fourth additional non-power generation application of the fourth embodiment refers to a retractile bridge function. FIG. 27 is a top view of the fourth embodiment of the present invention showing the articulated linkage 83 as shown in FIG. 21, working as an extensible bridge structure between opposed shores or sides of a river or water channel. Additional hinge-like foldable modular floor platforms 103 are attached at the top of the articulated linkage 83, as the one shown in FIG. 21, allowing the transit over the bridge. FIGS. 28a and 28b are partial perspective views of the modular floor platforms 103 placed on one section of the articulated linkage 83, joined between them by means of a pin 104, which also provides the joining between the modular floor platforms 103 and the planar articulation 85 (as shown in FIG. 21). FIG. 28a shows a non-specific moment during the travel of the bridge, when the modular floor platforms 103 are still folded, not in flat state and not ready to be used for transit. FIG. 28b shows the moment when the bridge has stopped reaching the opposed shore of the river or water channel, with the modular floor platforms 103 completely extended and in a flat state, ready to be used for passing from one side to the other. The modular floor platforms 103 rest on the links of the articulated linkage 83, providing the mechanical support for the platforms.

For all the non-power generation related applications explained above for the fourth embodiment of the present invention, the modularity of the articulated linkage 83 and the sliding bar are an advantage since it allows to adapt the solution to any distance or length by adding more links and vessels to any existing devices.

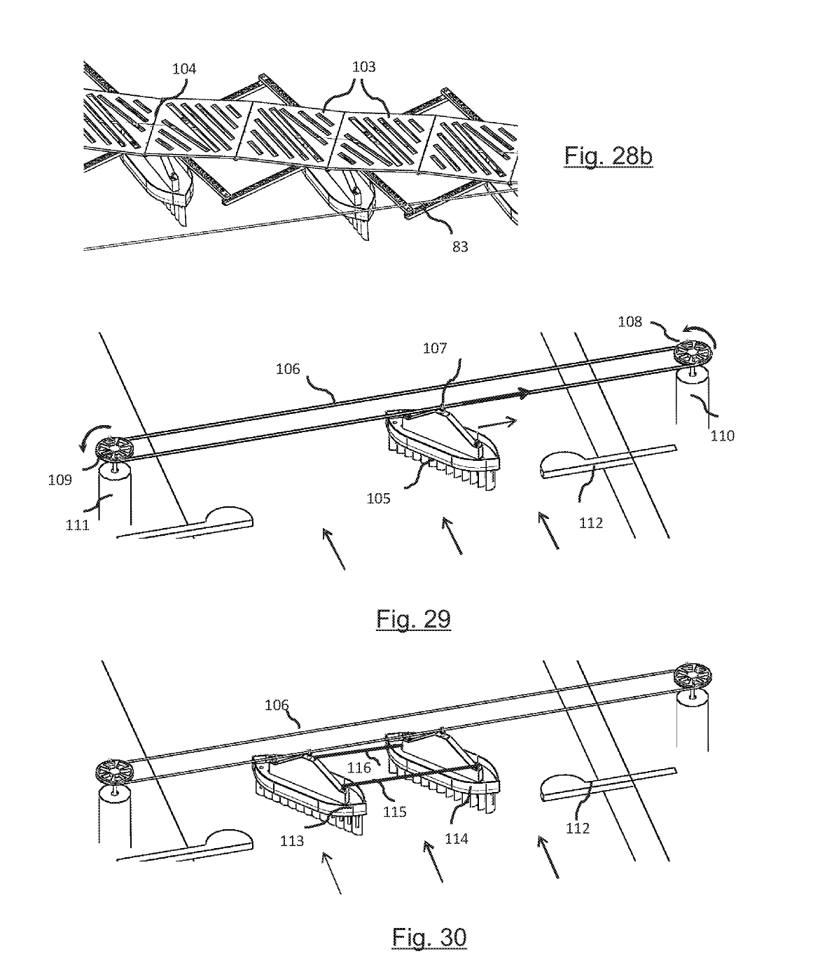

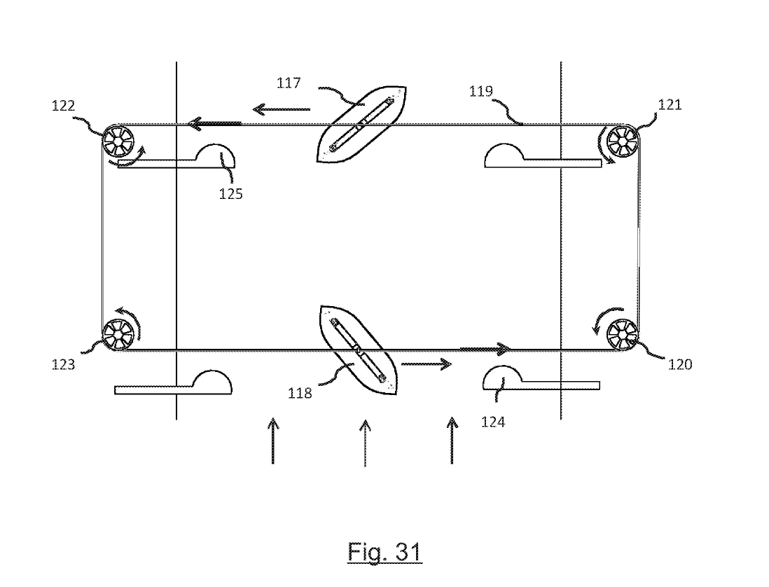

FIG. 29 is a general perspective view of the fifth embodiment of the present invention, which has a tenth additional vessel 105 which is propelled by the water current and is attached to a mobile transmission element 106 (mainly a chain, roller chain or cable), by means of a link 107 at the pivoting element of the vessel 105, with the mobile transmission element 106 being guided by a system of at least a first guiding wheel 108 and a second guiding wheel 109 (being pulleys or teethed sprockets depending on the transmission element used), which make rotate a spindle shaft driving a twelfth electric power generator unit 110 and a thirteenth electric power generator unit 111 respectively. The power generator units 110, 111 have a mechanical transmission with direction inversion and gear ratio capabilities, a flywheel disc and an electrical generator. FIG. 29 shows the vessel 105 moving leftwards (right side of the image) producing a counter clockwise rotation on the guiding wheels 108,109. Once the vessel 105 leading edge of the bow hull makes contact with the fixed stopper 112 it starts the reorientation of the vessel 105, by means of either the keels method or the inertia method, as already disclosed above. The pivoting element of the vessel 105 allows the vessel 105 to rotate about the pivoting axis in order to change its attack angle inverting the movement direction. There is also a locking mechanism as explained for all the embodiments which locks the vessel 105 to maintain its attack angle or is released in order to allow it reorienting. The vessel 105 will travel on leftwards and rightwards alternating direction without human intervention trailing the transmission element 106 as it moves. Two or more vessels can be arranged in order to increase the transmitted force to the power generation unit. FIG. 30 shows a top view of multiple vessels 113,114 attached to the same side of the transmission element 106. Both vessels 113,114 are restricted to have a parallel attack angle by means of the articulated bars 115,116, in such a way that the total force on the transmission element 106 is proportional to the sum of the lift force of all the vessels 113,114. There is not as specific number of vessels, but its number is limited to the width of the water channel or river, understanding that it is desirable to have enough room for the vessels to travel in order to make a more continuous supply of force for the power generation unit. When using two or more vessels joined by articulated bars 115 and 116 as shown in FIG. 30 it is only possible to reorient the vessels by means of the inertia method.

FIG. 31 is a top view of the fifth embodiment with an arrangement of two vessels 117,118 traveling in opposite directions, each one attached to a different side of the same transmission element 119. The propelling force on each of the vessels 117,118 is additive to the overall force transmitted by the transmission element 119 to the electric power generator units 120,121,122,123, being any or all of them generating power. The two vessels 117,118 travel synchronized in such a way that both will reach the fixed stoppers 124,125 respectively at the same time in order to reorient their attack angle by means of the keels method or the inertia method, to start their travel in opposite direction.

Any use resulting from the combination of two or more of the five embodiments of the modular guided traveling vessel power generator system disclosed in this document represent a logical application of the presented technology, for that reason being included on the scope of this document.

Figures are not to scale. The actual dimensions and/or shape of each of the elements of the present invention may vary. Only essential and relevant details of the device are shown, however one skilled in the art can appreciate how the present invention may be accomplished, without undue experimentation. As the main function of the device relates to transforming the hydrokinetic energy of a water source into a lift force acting with perpendicular direction to such current on the submerged portion of a vessel 1 with an attack angle respect to the current, it is theoretically well known from the aerodynamic science applied to airfoils that such lift force is proportional to geometrical elements of the vessel 1 (like the curvature of the hull of the vessel 1 and total area projected perpendicular to the current), the attack angle of the vessel 1 respect to the current, and properties of the current flow (speed and density). For this reason, the present description uses a generic symmetric shape of the vessel 1 to describe the operating principles, but it is understood that the physical application of the device and method here described to a specific location and water conditions would require specific vessel hulls shapes obtained from aerodynamic studies, even it would imply the use of a mono-hull vessel or a catamaran hull type. In the same way, the bottom side of the vessel 1 is represented on the drawings composed by a non-defined number of keels 12, but for some cases as the ones explained in detail in reorienting process by means of the inertia method, the bottom side of the vessel could use no keel at all or even a single fixed keel. For all of the drawings explained in this document, the three parallel arrows represent the direction of the water current, while the single arrow either lineal or curved means the displacement or turning direction of the element close to such arrow.

While the preferred embodiment and various alternative embodiments of the invention have been disclosed and described in detail herein, it may be apparent to those skilled in the art that changes in form and detail may be made therein without departing from the spirit and scope of the invention.

1. A modular guided traveling vessel power generator system comprising:
at least a floating vessel propelled by a fluid current and having orientation means, the vessel configured for rotating around a pivoting axis by means of a pivoting element attached to
a guiding system configured for guiding the vessel in a linear alternative direction perpendicular to the fluid current,
and a transforming mechanism configured for transforming the linear movement of the vessel into another movement which drives
at least a power generator unit.

2. The modular guided traveling vessel power generator system according to claim 1, wherein the orientation means of the vessel comprise at least a keel configured for rotating around a rotating axis parallel to the pivoting axis of the vessel.

3. The modular guided traveling vessel power generator system according to claim 1, wherein the orientation means of the vessel comprise a plurality of keels grouped in a bow keels group and a stern keels group.

4. The modular guided traveling vessel power generator system according to claim 1, wherein the orientation means of the vessel comprise inertial means configured for exerting a force over the vessel and rotating it around the pivoting axis.

5. The modular guided traveling vessel power generator system according to claim 1, wherein the guiding system comprises
a pulleys cable and
a pivoting cable parallel to the pulleys cable,
the vessel joined to the pivoting cable by means of the pivoting element, both cables perpendicular to the fluid current, and
two handling bars of variable length joining the pulleys cable and the vessel, said handling bars defining an attack angle of the vessel regarding the fluid current.

6. The modular guided traveling vessel power generator system according to claim 4, wherein the transforming mechanism comprises
first pulley mechanisms linking the handling bars to the pulleys cable,
a second pulley mechanism linking the vessel to the pivoting cable,
first and second electric power generator units placed on the first pulley mechanisms,
and third electric power generator units placed on the second pulley mechanism,
both pulley mechanisms configured for respectively rolling over the cables and driving respectively the electric power generator units.

7. The modular guided traveling vessel power generator system according to claim 1, wherein the guiding system comprises
a pivoting cable perpendicular to the fluid current, to which the vessel is joined by means of the pivoting element.

8. The modular guided traveling vessel power generator system according to claim 1, wherein the transforming mechanism comprises
a first trailing cable connecting the vessel to
a reel, which is rotated by the movement of the vessel, and
a fourth electric power generator unit placed on the reel and driven by the rotation of the reel.

9. The modular guided traveling vessel power generator system according to claim 6, wherein the transforming mechanism comprises at least a rod and crank mechanism, which comprises in turn
at least a rod bar having one of its ends articulated to the vessel and the other end articulated to
a crank bar articulated in turn to
a fifth electric power generator unit attached to the pivoting cable driven by the crank bar.

10. The modular guided traveling vessel power generator system, according to claim 8, wherein
it comprises a plurality of vessels attached to the rod bar of the transforming mechanism,
the vessels linked together by means of articulated bars which makes the vessels move and turn always in parallel.

11. The modular guided traveling vessel power generator system according to claim 8, wherein the rod and crank mechanism comprises a plurality of rod bars, each rod bar having one of its ends articulated to a vessel and the other end articulated to the crank bar.

12. The modular guided traveling vessel power generator system according to claim 8, wherein a plurality of rod and crank mechanisms are attached to a single vessel.

13. The modular guided traveling vessel power generator system according to claim 1, wherein
the guiding system is mobile and deformable, and placed perpendicular to the fluid current, having one of its ends fixed
and at least a vessel is attached to the guiding system, which moves together with the vessel.

14. The modular guided traveling vessel power generator system according to claim 12, wherein the guiding system further comprises
a sliding bar configured to move perpendicular to the fluid current having a guiding element anchored to the shoreline of the current, and
a tensing cable which rolls and unrolls on a first reel wheel and a second reel wheel, and passes through a fifth pulley.

15. The modular guided traveling vessel power generator system according to claim 12, wherein the guiding system further comprises
an articulated extensible-compressible linkage, which in turn comprises a plurality of arms articulated together by means of planar articulations and hinge articulations, the articulated extensible-compressible linkage extending or contracting according the moving direction of the vessel, and
a tensing cable which rolls and unrolls on a first reel wheel and a second reel wheel, and passes through a fifth pulley.

16. The modular guided traveling vessel power generator system according to claim 1, wherein the guiding system is a mobile transmission element selected between a chain, roller chain and cable, guided by a first guiding wheel and a second guiding wheel.

17. The modular guided traveling vessel power generator system according to claim 15, wherein it comprises a plurality of vessels linked together by means of articulated bars, which keep all the vessels oriented with the same attack angle.

18. A method for generating power comprising
orientating and pivoting a floating vessel propelled by a fluid current around a pivoting axis,
guiding the floating vessel in a linear alternative direction perpendicular to the fluid current, and
transforming the linear movement of the floating vessel into another movement which drives at least a power generator unit.

19. The method for generating power according to claim 17, wherein orientating and pivoting the floating vessel comprises rotating at least a keel around a rotating axis of the keel parallel to the pivoting axis.

20. The method for generating power according to claim 17, wherein orientating and pivoting the floating vessel comprises exerting a force over the vessel by means of inertial means and rotating it around the pivoting axis.

21. The method for generating power according to claim 17, wherein transforming the linear movement of the floating vessel into another movement which drives at least a power generator unit comprises driving electric power generator units by means of pulley mechanisms rolling over guiding means.
